(19) United States
(12) Patent Application Publication
(10) Pub. No.: US 2017/0004516 A1
(43) Pub. Date: Jan. 5, 2017

(54) IDENTIFYING CANDIDATE ADVOCATES FOR AN ORGANIZATION AND FACILITATING POSITIVE CONSUMER PROMOTION

(71) Applicant: MedicalGPS, LLC, Franklin, TN (US)

(72) Inventors: Martin R. HUDSON, Franklin, TN (US); Jerry L. STONE, Williamsport, TN (US)

(21) Appl. No.: 14/789,189

(22) Filed: Jul. 1, 2015

(51) Int. Cl. G06Q 30/02

(52) U.S. Cl. CPC G06Q 30/0203

(57) ABSTRACT

A method for identifying candidate advocates for an organization includes obtaining a plurality of responses to a questionnaire completed by respective respondents based on transactions with the organization in which the questionnaire comprises a primary question and a plurality of secondary questions each having an ordered list of answer choices, calculating a respective correlation coefficient for each secondary question between the answer choices selected for the secondary question and the primary question in the plurality of responses, defining a criteria for assessing the responses to identify candidate advocates from the respondents that specifies, for a set of the secondary questions for which the respective correlation coefficients are greater than a threshold value, which answer choices for the set of secondary questions can be selected in a given response to satisfy the criteria, and identifying the respective respondent for each response that satisfies the criteria as a candidate advocate.

### BACKGROUND OF THE INVENTION

Exemplary embodiments of the present invention relate to customer satisfaction research and automated analysis of customer satisfaction data for identifying satisfied and loyal consumers of an organization. More specifically, exemplary embodiments relate to systems and methods for performing automated correlation analysis of survey response data obtained through customer satisfaction research to identify a set of highly loyal consumers of an organization that have a high likelihood of providing positive promotion for the organization based on an assessment of their overall experience with the organization.

The direction of strategic business research has paralleled a major paradigm shift in how companies compete, from a focus on production to a focus on marketing. Up until the 1950s, the prevailing concept in business strategy was based on an assumption that profitability was predominantly correlated with creation a product of high technical quality. Over time, however, the customer has become the primary impetus behind strategic business decisions. In a competitive marketplace where businesses compete for customers, customer satisfaction is seen as a key differentiator and, thus, has increasingly become a key element of business strategy. As a result, customer satisfaction research is among the most widely conducted marketing research activities.

An example of this concept is the loyalty business model, which is a business model utilized in strategic management under which company resources are employed so as to increase the loyalty of customers based on an expectation that corporate objectives will be met or surpassed. A basic description of this type of model is that quality of product or service leads to customer satisfaction, which leads to customer loyalty, which leads to profitability, and a fundamental assumption upon which this representation is based is that organizations need to retain existing customers while targeting non-customers. One of the reasons that has been recognized for the increased profitability associated with customer retention efforts is that satisfied customers are more likely to initiate word-of-mouth recommendations and referrals, which is a form of marketing that is both free and highly effective.

To effectively manage customer satisfaction, business need reliable and representative measures of satisfaction. The usual measures of customer satisfaction involve a survey that consists of a number of statements or questions using a Likert technique or scale, in which the surveyed customer is asked to evaluate each statement in terms of their perceptions and expectations of performance of the organization being measured. Customer satisfaction is generally measured on a five-point scale, and individuals who rate their satisfaction level as ‘5’ are considered likely to become return customers and possibly recommend the organization to friends, relatives and colleagues, which can provide a powerful marketing advantage. In this regard, a secondary metric related to customer satisfaction is willingness to recommend, which is a measure of the percentage of surveyed customers who indicate that they would recommend a brand to friends.

One of the more popular measures of willingness to recommend is the Net Promoter Score (NPS), which is a customer loyalty metric developed by Fred Reichheld. NPS measures the loyalty that exists between a provider and a consumer based on one direct question: “How likely is it that you would recommend our company/product/service to a friend or colleague?” The scoring for this answer is most often based on a 0 to 10 scale. “Promoters” are defined as those who respond with a score of 9 or 10 and are considered loyal enthusiasts, “Detractors” are defined as those who respond with a score of 0 to 6 and are considered unhappy customers, and “Passives” are defined as those who respond with a score of 7 and 8. NPS, which can range from −100 (everybody is a Detractor) to +100 (everybody is a Promoter), is calculated by subtracting the percentage of customers who are Detractors from the percentage of customers who are Promoters (such that Passives only count towards the total number of respondents in the formula).

Proponents of the NPS approach have claimed that the score can be used to motivate an organization to become more focused on improving products and services for consumers. Nevertheless, there are various ways in which customer loyalty can be measured, and others have determined that the precision of the NPS is low compared to other measures of loyalty, that “satisfaction” and “liking” are better predictors of actual customer recommendations than “likelihood to recommend,” and that a single item question is significantly less reliable and more volatile than a composite index as a predictor of future customer loyalty behaviors.

### SUMMARY OF THE INVENTION

Exemplary embodiments of the present invention are related to a method for analyzing consumer feedback to identify candidate advocates for an organization. The method includes accessing a survey results database stored within a data store to obtain a set of survey results data representing a plurality of responses to a questionnaire that have each been completed by a respective consumer respondent of a plurality of consumer respondents based on a transaction the consumer respondent has engaged in with the organization in which the questionnaire comprises a primary question and a plurality of secondary questions that are each constructed with a closed-ended ordinal response scale having an ordered list of answer choices that are each assigned a numeric value along a continuum corresponding to the response scale for the question and from which one answer choice is selected to answer the question, automatically processing the survey results data to calculate a respective correlation coefficient for each secondary question that indicates a level of dependency between the numeric values assigned to the answer choices selected in the plurality of responses for the secondary question and the numeric values assigned to the answer choices selected in the plurality of responses for the primary question, evaluating the respective correlation coefficients calculated for the secondary questions to define a criteria for assessing the plurality of responses to identify candidate advocates from the plurality of consumer respondents, and automatically evaluating the survey results data to determine which of the plurality of responses satisfy the criteria and identifying the respective consumer respondent for each of the responses that is determined to satisfy the criteria as a candidate advocate for the organization. The questionnaire comprises a primary question that addresses a primary indicator of consumer loyalty and a plurality of secondary questions each addressing a corresponding aspect of consumer experience during transactions with the organization. The criteria specifies, for a set of secondary questions of the plurality of secondary questions for which the respective correlation coefficients are greater than a threshold value, which of the answer choices for the set of secondary questions can be selected in a given response to the questionnaire for the response to satisfy the criteria.

Exemplary embodiments of the present invention that are related to data processing systems and computer program products corresponding to the above-summarized method are also described and claimed herein.

The above-described and other features and advantages realized through the techniques of the present disclosure will be better appreciated and understood with reference to the following detailed description, drawings, and appended claims. Additional features and advantages are realized through the techniques of the present invention. Other embodiments and aspects of the invention are described in detail herein and are considered a part of the claimed invention.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a block diagram illustrating the components of an exemplary operating environment 100 within which exemplary embodiments of an advocate identification system in accordance with the present invention can be implemented;

FIG. 2 is a chart illustrating an exemplary set of hypothetical response data and an outline example set of calculations that can be performed in a correlation analysis conducted in accordance with exemplary embodiments of the present invention;

FIG. 3 is an illustration of a non-limiting example of a body portion of an exemplary endorsement solicitation request message template that may be utilized in exemplary embodiments of the present invention;

FIG. 4 is a flow diagram illustrating a process of analyzing consumer feedback to identify candidate advocates for an organization in accordance with an exemplary embodiment of the present invention;

FIG. 5 is an illustration of a non-limiting example of a survey questionnaire that may be utilized for implementing exemplary embodiments of the present invention; and

FIG. 6 is a block diagram of an exemplary computer system that can be used for implementing exemplary embodiments of the present invention.

The detailed description explains exemplary embodiments of the present invention, together with advantages and features, by way of example with reference to the drawings, in which similar numbers refer to similar parts throughout the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered to be within the scope of the claimed invention.

### DETAILED DESCRIPTION

While the specification concludes with claims defining the features of the invention that are regarded as novel, it is believed that the invention will be better understood from a consideration of the description of exemplary embodiments in conjunction with drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form, and it will be apparent to those skilled in the art that the present invention may be practiced without these specific details. Further, the terms and phrases used herein are not intended to be limiting but rather to provide an understandable description of the invention.

As will be explained in greater detail below, exemplary embodiments of the present invention may be implemented to provide a mechanism for organizations to perform a concrete and precise loyalty assessment of customers that can provide such organizations with concrete data identifying the most loyal customers of the organizations, termed “advocates,” rather than simply generally loyal or satisfied customers. In this regard, exemplary embodiments can be implemented in a manner that that provides some level of assurance that such identified advocates would likely be willing to publicly promote an organization by providing positive reviews, recommendations, or other type of endorsements on behalf of the organization.

In particular, in contrast to current mechanisms that employ a “one question” philosophy that simply allows consumers to identify themselves as loyal to an organization, example embodiments can be implemented to provide a more concrete and precise mechanism that takes the complete consumer experience with an organization into consideration in determining candidate advocates of the organization by focusing on an identified set of consumer touch-points covering aspects throughout the entire consumer experience with the organization to define a completely “highly satisfied” consumer. More specifically, exemplary embodiments can be implemented to obtain and analyze results of a survey in which a questionnaire constructed with a set of questions addressing such an identified set of consumer touch-points is completed by consumer respondents who have engaged in a transaction with the organization, perform a correlation analysis of the survey results to identify the aggregate responses to the survey questions that have the highest correlation to loyalty, define a criteria for identifying candidate advocates of the organization based on the results of the correlation analysis, and utilize the criteria to perform an analysis of the survey responses from each consumer respondent to identify a set of only the most loyal customers of the organization. In exemplary embodiments, such an identified set of the most loyal customers of an organization can be further utilized by the organization in various manners, such as to maintain a list of such identified candidate advocates, determine a value that corresponds to a percentage of total consumers that are identified as candidate advocates, and provide a streamlined approach for soliciting and facilitating public promotion from the identified candidate advocates.

Exemplary embodiments can thereby provide a mechanism for determining candidate advocates of an organization that is more comprehensive and precise than present methods that simply define consumers that are generally loyal or satisfied. Rather than simply being likely to recommend if asked, an advocate can be expected to defend and promote their positive views with respect to the organization. In this respect, advocates can be viewed a subset of those consumers that are generally loyal to an organization. In certain circumstances, even though a consumer may recommend an organization, that specific consumer may still have had one or more aspects of their transaction with the organization that they deem to be less than favorable, and they may bring this “less than favorable” aspect to the attention of someone they are recommending the organization to in a manner that qualifies their recommendation to an extent. While this usually means “less than favorable” aspect was not an important factor in their decision to provide the recommendation, this aspect may happen to nevertheless be an important factor in the opinion of the individual receiving the recommendation. By implementing a mechanism that considers all aspects of the entire consumer experience that may have a measurable impact on consumer satisfaction, exemplary embodiments can provide a level of assurance that each of the identified candidate advocates is satisfied with their overall experience with no or only insignificant “less than favorable” aspects, thereby minimizing the likelihood that identified candidate advocates would include negative qualifying statements in their recommendations.

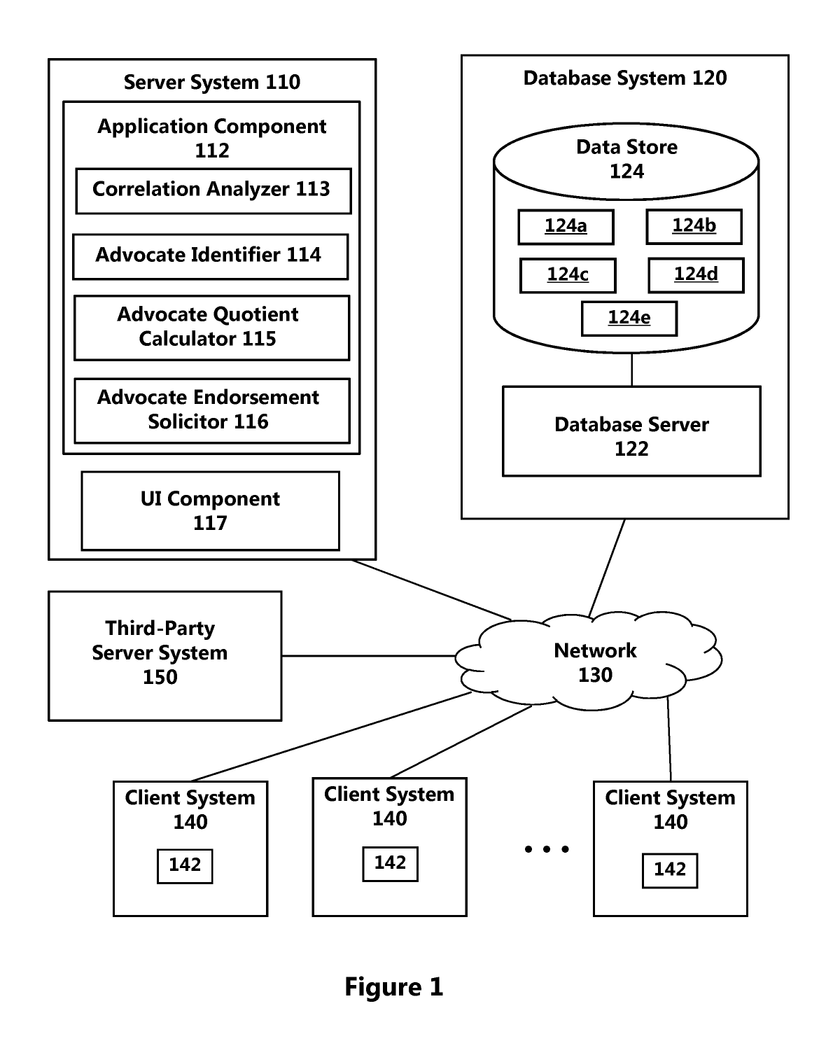

Referring now to FIG. 1, a block diagram illustrating the components of an exemplary operating environment 100 within which exemplary embodiments of an advocate identification system in accordance with the present invention can be implemented is provided. It should of course be understood that FIG. 1 is intended as an example, not as an architectural limitation for different embodiments of the present invention, and therefore, the particular elements depicted in FIG. 1 should not be considered limiting with regard to the environments within which exemplary embodiments of the present invention may be implemented.

As shown in FIG. 1, exemplary environment 100 generally includes a server system 110 that is communicatively coupled to and configured to commonly access a database system 120 via one or more communication networks, which are represented in FIG. 1 as network 130. In some exemplary embodiments, operating environment 100 can further include one or more user systems 140 that are operatively coupled to server system 110 via network 130 and configured to provide users of the user systems with the ability to commonly access server system 110 through operation of any of the user systems, and at least one third-party server system 150 that is operatively coupled to server system 110 via network 130 to enable other functionality that may be accessed and utilized by the server system to provide and/or enhance the services provided by the server system discussed herein.

In exemplary embodiments, operating system 100 can include additional servers, clients, and other devices and components not shown in FIG. 1. The particular architecture depicted in FIG. 1 is provided as an example for illustrative purposes and, in exemplary embodiments, any number of user systems 140 may be connected to server system 110 at any given time via network 130, and server system 110 can comprise multiple server components and databases located within a single server system or within multiple server systems, where the multiple server systems are integrated with or accessible by users of user systems 140 as a distributed server system via network 130.

In exemplary embodiments, network 130 can be any type of network familiar to those skilled in the art that can support data communications using any of a variety of commercially-available networking protocols now available or later developed including, but not limited to, the TCP/IP, SNA, IPX, AppleTalk, and the like. Network 130 can be configured to facilitate communications between server system 110 and database system 120, and between server system 110 and client systems 140, as well as communications with and between other devices and computers connected together within operating environment 100, by any suitable wired (including optical fiber), wireless technology, or any suitable combination thereof, including, but not limited to, personal area networks (PANs), local area networks (LANs), wireless networks, wide-area networks (WAN), the Internet, an intranet, and virtual networks including virtual private networks, and the network may also utilize any suitable hardware, software, and firmware technology to connect devices such as, for example, optical fiber, Ethernet, ISDN (Integrated Services Digital Network), T-1 or T-3 link, FDDI (Fiber Distributed Data Network), cable or wireless LMDS network, Wireless LAN, Wireless PAN (for example, IrDA, Bluetooth, Wireless USB, Z-Wave and ZigBee), HomePNA, Power line communication, or telephone line network. Such a network connection can include intranets, extranets, and the Internet, may contain any number of network infrastructure elements including routers, switches, gateways, etc., can comprise a circuit switched network, such as the Public Service Telephone Network (PSTN), a packet switched network, such as the global Internet, a private WAN or LAN, a telecommunications network such as GSM, GPRS, EDGE, UMTS, 3G, 2.5 G, CDMA, CDMA2000, WCDMA, EVDO etc., a broadcast network, or a point-to-point network.

In the present exemplary embodiment, as further illustrated in FIG. 1, server system 110 includes an advocate identification application component 112 comprising a plurality of program modules that are executed within the server system 110 for implementing the exemplary advocate identification services, as well as other processes and services and further described hereinbelow, and database system 120 is comprised of a database server 122 that is coupled to a data store 124, which stores a plurality of databases and other data sources (such as computer files) that are maintained by database server 122, accessed by application component 112 via database services provided at a front end by database server 122, and store information on a variety of matters that is utilized in providing the services implemented by the application component at the server system, as described below in greater detail. As used herein, the term “data store,” “data storage unit,” storage device“, and the like can to any suitable memory device that may be used for storing data, including manual files, machine-readable files, and databases. As used herein, the terms” data,” “content,” “information” and similar terms may be used interchangeably to refer to data capable of being captured, transmitted, received, displayed, and/or stored in accordance with various example embodiments. Thus, use of any such terms should not be taken to limit the spirit and scope of the disclosure.

In exemplary embodiments, application component 112, database server 122, and data store 124 may be implemented independently, implemented together within a single, integrated computing device, implemented within a plurality of computing devices locally coupled to each other via a suitable communication medium, such as a serial port cable, telephone line or wireless frequency transceiver, implemented within a plurality of computing devices remotely coupled to each other via network 130, or any suitable combination thereof. Thus, in the present disclosure, where a computing device is described herein to receive data from another computing device, it will be appreciated that the data may be received directly from another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like. In exemplary embodiments, server system 110 and database system 120 can each be connected to network 130 through a collection of suitable security appliances, which may be implemented in hardware, software, or a combination of hardware and software.

In exemplary embodiments, server system 110, database server 122, and any other servers employed within exemplary operating environment 100 can each be implemented within any suitable general purpose and/or specialized server computing system or systems such as, merely by way of example, a workstation computer, a mainframe computer, a server computer (for example, PC servers, UNIX servers, mid-range servers, IBM RS/6000 workstations and servers running the AIX operating system, or an IBM zSeries eServer running z/OS, z/VM, or LINUX OS), rack-mounted servers, a server cluster, a distributed computing system, a cloud based computing system, or the like, as well as any of the various types of computing systems and devices described below with reference to the user systems 140. While the exemplary embodiment illustrated in FIG. 1 depicts server system 110 and database server 122 as individual components, the applications provided by these servers, or various combinations of these applications, may actually be server applications running on separate physical devices. In this regard, server system 110 may be implemented using any of a variety of architectures and may comprise a number of computers connected together via a network and, therefore, may exist as multiple separate logical and/or physical units, and/or as multiple servers acting in concert or independently, wherein each server may be comprised of multiple separate logical and/or physical units.

As noted above, data store 124 can comprise a plurality of databases and other data sources that are accessible and/or maintained by application component 112 via database server 122, including a survey description file 124a, a survey results database 124b, a survey respondent information database 124c, an advocate information file 124d, and one or more additional databases and/or files 124e that may be used for storing any other suitable information that may be utilized by server system 110 (for example, system usage data, audit trail data, data used internally within the system by application component 112, and the like). In exemplary embodiments, the various databases and files maintained within data store 124 can be maintained as groups within one or more larger databases or maintained individually.

In the present exemplary embodiment, survey description file 124a is used to maintain information describing a survey that is implemented for an organization for the purpose of receiving feedback from consumer respondents who engage the organization regarding their overall experience with the organization and identifying a set of the most-highly satisfied consumers among the respondents. As used herein, a survey should be understood to generally refer to a method used to collect information from a sample of individuals in a systematic way. In the present exemplary embodiment, the survey is implemented through the use of a questionnaire that comprises a series of questions relating to one or more survey topics that each respondent answers in a set format by selecting from a set of standardized answers for each question (that is, each question is a closed-ended question that has the respondent pick an answer from a given number of mutually-exclusive and collectively-exhaustive options). The questionnaire should be properly constructed and responsibly administered to accurately reflect the views and opinions of the participants. As noted above, the intent of the survey is to identify the respondent consumers that are most satisfied in their overall experiences with the organization and indicate a high level of loyalty to the organization by measuring consumer satisfaction with respect to a set of specific touch points that address the entire consumer experience in a typical transaction with the organization.

More specifically, the series of questions included in the questionnaire can be constructed based on a review of the business process and operations of the organization that is conducted to document noteworthy aspects of the typical chronological path of experiences and interactions of a consumer in a typical transaction for obtaining services and/or products from the organization and identify the key touch points related to aspects of this transaction path that, in view of relevant industry standards and guidelines, have a measurable impact on the consumer experience. To gain a suitable understanding of an organization's business process and operations, such a review can involve, for example, interviewing business owners, managers and key personnel; reviewing products and/or services offered; reviewing the methods by which products and/or services are delivered to consumers; and reviewing industry standards, research, and data and, if necessary, conducting additional research (such as by conducting a separate survey) to identify the aspects of the consumer experience in relation to the documented business process and operations implemented by the organization that have a measurable impact on consumer satisfaction and loyalty. In exemplary embodiments of the present invention, such a review will further involve determination of a primary indicator of consumer satisfaction that represents whether a consumer, in view of their complete experience with the organization, possesses a level of loyalty to the organization that would likely motivate the consumer to be an advocate on behalf of the organization.

Based on the results of such a review of the business process and operations of the organization, a list of survey questions to include in the questionnaire can be written that cover the aspects of the entire consumer experience in a typical transaction with the organization that are identified as having a measurable impact on consumer satisfaction and loyalty. Because the responses to the questions presented in the questionnaire from the respondents surveyed will be used in the present exemplary embodiment to, as described in greater detail below, perform a correlation analysis in which a level of dependency between each question and the determined primary indicator of consumer satisfaction is calculated, each question can be written in a single, uniform and exact manner that utilizes clear and comprehensible wording that is easily understandable for all educational levels, to address a single aspect of the consumer experience, and in a manner that is not biased, does not lead the respondent toward an answer, and does not make assumptions about the respondent. Moreover, the questions can be ordered within the questionnaire to flow logically from each question to the next such as, for example, in correspondence with the chronology the aspects of the typical consumer transaction with the organization. Additionally, the questionnaire will be constructed to include a final question that addresses the primary indicator of consumer satisfaction that is determined to represent whether a consumer, in view of their complete experience with the organization, possesses a level of loyalty to the organization that would likely motivate the consumer to be an advocate on behalf of the organization. Such a question may be, for example, phrased as follows: “I would recommend this organization to my family and friends. Do you agree or disagree?”

For purposes of the correlation analysis noted above, the questions can be formatted with closed-ended ordinal response scales, such as ordinal-polytomous scales in which the respondent has more than two ordered response options and/or dichotomous scales such as “yes/no” response options, that limit respondents with an ordered list of answer choices from which they must choose to answer the question by rating the situation addressed by the question along the scale continuum. The type and format of the response scales, as well as the number, nature, ordering, level of detail, and descriptiveness of the scale labels and whether responses to particular questions should be required or left optional, can be determined in view of the results of the review of the business process and operations of the organization described above and the level of measurement appropriate for each aspect of the consumer experience being addressed within the questionnaire with respect to the correlation analysis to be performed. Common examples are Likert-type scales in which respondents specify their level of agreement or disagreement on a agree-disagree scale for each Likert item (that is, a statement that the respondent is asked to evaluate by giving it a quantitative value on any kind of subjective or objective dimension, with level of agreement/disagreement being the dimension most commonly used) and 1-10 rating scales in which a person selects the number which is considered to reflect satisfaction with or the perceived quality of a service or product. The list of possible responses should be collectively exhaustive and mutually exclusive such that respondents do not find themselves with no category that fits their situation or in more than one category. The format of a typical symmetric five-level Likert item with clearly defined linguistic identifiers, for example, may be: “1. Strongly disagree”; “2. Disagree”; “3. Neither agree nor disagree”; “4. Agree”; and “5. Strongly agree.” In exemplary embodiments, the questionnaire can be constructed to include additional questions that are not directed to aspects of the consumer experience that will be involved in the correlation analysis (and, thus, are not required to be formatted with closed-ended ordinal response scales). Such additional questions may include, for example, questions regarding the date(s), time(s), and location(s) at which the transaction with the organization occurred, the particular type of transaction, and employees of the organization encountered by the respondent during the transaction, open-ended questions directed to soliciting further remarks and unusual or unexpected circumstances related to the transaction, questions requesting information pertaining to the respondent such as name, gender, age, and contact information, and an option for the respondent to request to have someone from the organization contact them.

Upon the questionnaire being constructed as described above, the validity and reliability of the questions and response scales included therein can be evaluated to the extent desired or possible through the application of logical and/or statistical procedures, and the questionnaire can be refined and/or modified based on the results of the evaluation to achieve a desired level at which each question measures what it intends to measure and produces consistent results. Other aspects of the questionnaire can also be determined in accordance with the goals for collection and analysis of the survey data, such as how the questions are presented on the page (or computer screen), use of white space, colors, graphics, et., and numbering of the questions. An example of a technique that can be employed for the purpose of checking the questionnaire and making sure it is accurately capturing the intended information is to pretest among a smaller subset of target respondents.

Upon the content and format of the questionnaire being constructed and refined as necessary or desired, information for rendering the questionnaire and other relevant information describing the questionnaire, such as a set of instructions to be provided by an administer (for example, instructions to be provided a staff member or instructions that are printed or automatically provided in the case of self-administered questionnaires) of the questionnaire to respondents, information used for interpretation of the responses (for example, the nature of the expected responses), and an indication of the specified question that addresses the primary indicator of consumer satisfaction that is determined to represent whether a consumer possesses a level of loyalty to the organization that would likely motivate the consumer to be an advocate on behalf of the organization can be stored within survey description file 124a of data store 124.

Along with construction of the questionnaire for the survey, other aspects of the methodology employed for the survey can also be determined to ensure that the survey process is valid and reliable for the purpose of collecting accurate data that is pertinent to the aspects of the consumer experience in relation to the documented business process and operations implemented by the organization that are identified as having a measurable impact on consumer satisfaction and loyalty and thereby indicative of a candidate advocate for the organization. Such aspects can include identification and selection of potential sample members, selection of methods for contacting sampled individuals, and selection of the mode for posing questions and collecting responses. The sample can be selected, for example, by first defining the population from which the sample is drawn (which, in the present exemplary embodiment, will be at least limited to consumers who have engaged in a transaction with the organization) and then determining a suitable sample size and using a suitable survey sampling technique, which may be selected from probability sampling methods, such as stratified sampling, simple random sampling, and systematic sampling, and non-probability sampling methods, such as convenience sampling, quota sampling, and purposive sampling. The method for contacting sampled individuals can be selected from, for example, online, email, telephone, or postal mail invitations. The mode of survey data collection can be selected from, for example, telephone, postal mail, face-to-face, paper-and-pencil, electronic or computerized (such as online or mobile surveys), and hybrids of these modes. Other aspects of the survey methodology can involve employment of nonresponse reduction techniques, determination of the method by which the survey data is compiled from the survey response (for example, manually or automatically), employment of appropriate controls for ensuring the validity of the survey process (for example, controls for ensuring that survey data is compiled accurately and access to and ability to manipulate survey data is restricted), and any suitable post-survey adjustment procedures. In general, exemplary embodiments of the present invention are not limited to particular survey methodologies, and any suitable aspects of survey methodology now known or later developed in the art can be employed to collect survey data in conjunction with exemplary embodiments of the present invention.

Upon these aspects of the survey methodology being determined, all aspects of the methodology can be reviewed and evaluated for validity and reliability to the extent desired using any suitable procedure(s), and the methodology can be refined and/or modified based on the results of the evaluation to ensure a valid survey methodology is established and can be implemented. Upon the survey methodology being validated, information describing the methodology can be stored within survey description file 124a of data store 124 in association with the information pertaining to the questionnaire.

Once an appropriate questionnaire is constructed and a suitable survey methodology is determined, the survey can be conducted in accordance therewith, and the survey results can be collected and the corresponding survey data can be compiled within survey results database 124b. Survey results are reflected in a plurality of questionnaire responses, with each response relating to answers to at least a subset of the plurality of questions completed by a single respondent. In exemplary embodiments, regardless of the particular methodology by which the survey is initially conducted, questionnaire responses are ultimately reduced to an electronic format, and the survey data pertaining to the responses to the questionnaire completed by each sampled respondent can be maintained within a respective information record within survey results database 124b. An information record may be, for example, a program and/or data structure that tracks various data related to a corresponding type of information record.

Additionally, data pertaining to each sampled respondent can be compiled and maintained within a respective information record within survey respondent information database 124c that is associated with the respective information record within survey results database 124b for the respondent. Such data within the respective information record for each sampled respondent within survey respondent information database 124c may include items of information such as, for example, respondent name, applicable information pertaining the completion of the questionnaire such as a date, time, and location, and respondent contact information (such as email address, telephone number, and mailing address). The items of information pertaining to respondents included within survey respondent information database 124c may be compiled based on responses to additional questions included within the questionnaire that are not directed to aspects of the consumer experience involved in the correlation analysis (and, thus, are not required to be formatted with closed-ended ordinal response scales). Compiling the information within survey results database 124b and survey respondent information database 124c may also involve, for example, discarding any information records for sampled respondents within survey results database 124b, along with the corresponding information records for the sampled respondents within survey respondent information database 124c, for which the set of answers included in the corresponding questionnaire responses are deemed insufficient or otherwise inadequate for performing the survey results analysis described below (for instance, questionnaire responses for which the respondents did not provide an answer for the specified question that addresses the determined primary indicator of consumer satisfaction or did not provide an answer to any other question that is determined to be required for the survey results analysis).

Upon the survey data pertaining to the responses to the questionnaire completed by each sampled respondent being compiled within survey results database 124b, the collected survey data can be analyzed for statistical validity to ensure that a reasonable set of data has been gathered that is suitable for performing the correlation analysis with respect to the final question of the questionnaire that addresses the primary indicator of consumer satisfaction that is determined to represent whether a consumer, in view of their complete experience with the organization, possesses a level of loyalty to the organization that would likely motivate the consumer to be an advocate on behalf of the organization. Such an analysis, can involve, for example, an assessment of whether the sample size is statistically valid and performance of confidence level and margin of error analysis based on a comparison of the survey results with the total population. In this regard, if it is determined that any of the sample size, confidence level, margin of error, and the like are not adequate, additional survey data can continue to be accumulated and compiled within survey results database 124b, and the statistical validity analysis can be performed until the results of the analysis are determined to be adequate. In exemplary embodiments, the analysis of the collected survey data can further involve determining the sample size (that is, the quantity or count of the number of information records for questionnaire responses that have been compiled within survey results database 124b) and storing an indication of the sample size within the survey results database 124b.

Upon the survey results data being verified as adequate, a correlation analysis can be performed with respect to response elements of the survey data collected for each of the secondary questions directed the aspects of the entire consumer experience in a typical transaction with the organization that are identified as having a measurable impact on consumer satisfaction and loyalty and covered within the questionnaire relative to the survey data response elements collected for the primary question that addresses the primary indicator of consumer satisfaction that is determined to represent whether a consumer, in view of their complete experience with the organization, possesses a level of loyalty to the organization that would likely motivate the consumer to be an advocate on behalf of the organization. In the present exemplary embodiment, as noted above, advocate identification application component 112 comprises a plurality of program modules that are executed within the server system 110 for implementing the correlation analysis, as well as other processes and services.

More specifically, as illustrated in FIG. 1, the modules implemented by application component 112 include a correlation analyzer 113, an advocate identifier 114, and advocate quotient calculator 115, and an advocate endorsement solicitor 116. As further illustrated in FIG. 1, server system 110 also includes a user interface component 117 that is coupled to application component 112 and implements a user interface to enable access to the services provided by the application component to control management and operation of the application component. User interface component 117 may implement, for example, a graphical user interface (GUI) that renders a common display structure to represent the services provided by application component 112 for a user of a client platform, a communication user interface, other type of interface, or a combination thereof, configured to enable communication to server system 110, and may be accessible via a computing device communicatively coupled to the server system, such as a user system that is locally connected to or integrated with the server system or any of user systems 140 that are operatively coupled to server system 110 via network 130.

In exemplary embodiments, each user system 140 is a user terminal or other client device to which one or more users have access. It should be noted that the term “user” is used herein to refer to one who uses a computer system, such as one of user systems 140. As described in greater detail below, user systems 140 are each operable by such users to access server system 110 via network 130 and act as clients to access services offered by application component 112.

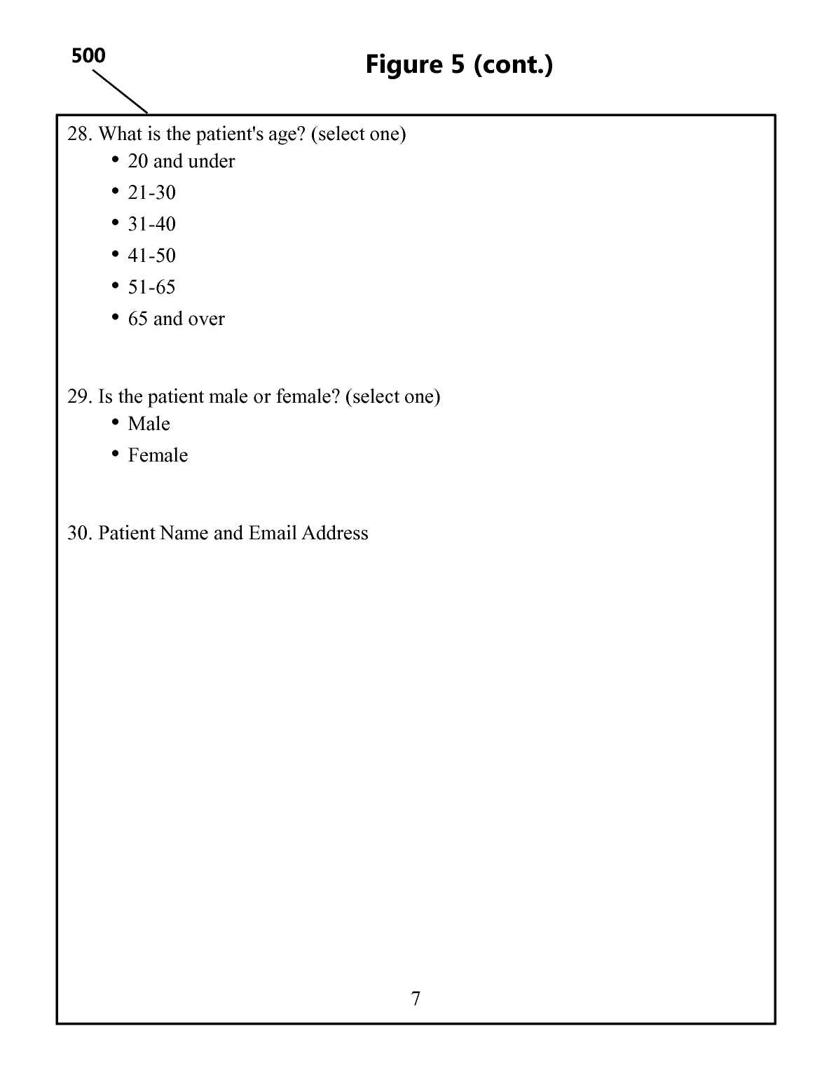

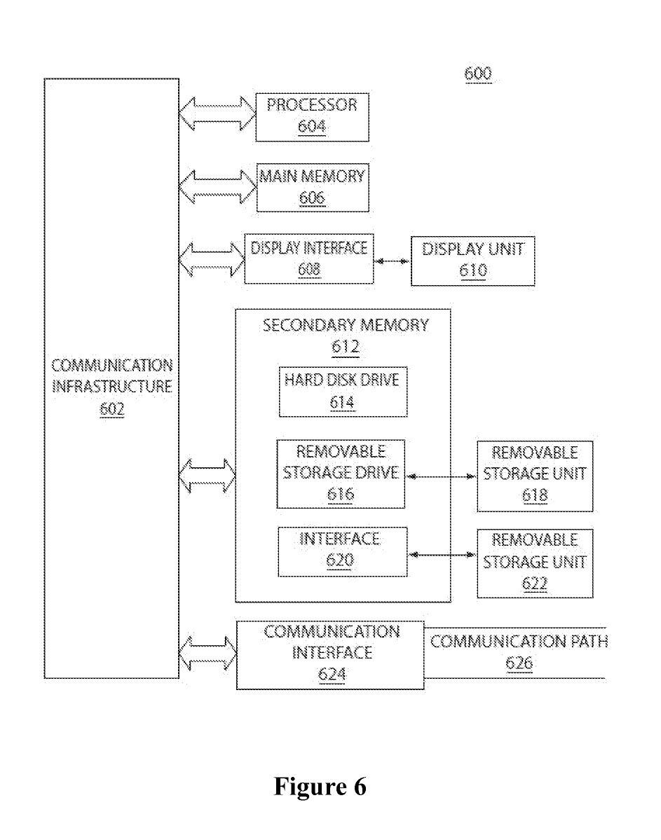

In exemplary embodiments, the computer systems of user systems 140 can be any of a wide range of suitable computing devices such as one or more workstations, desktop computers, laptops, or other personal computers (PCs) (for example, IBM or compatible PC workstations running versions of the Microsoft Windows operating system or Linux OS, Macintosh computers running versions of the MAC OSX operating system, or equivalent), non-traditional-computer digital devices such as Personal Digital Assistants (PDAs) and other handheld or portable electronic devices, smart phones and other mobile handsets, tablet computers, netbook computers, game consoles, home theater PCs, desktop replacement computers, and the like, or any other suitable information processing devices. An exemplary computer system for user systems 140 is described in greater detail below with reference to FIG. 6.

In general, during operation of exemplary operating environment 100, a user system 140 first establishes a connection to server system 110 via network 130. Once the connection has been established, the connected user system may directly or indirectly transmit data to and access content from application component 112. For this purpose, each user system 140 can implement a respective client application 142 that executes on the user system and allows a user to interact with server system 110 to access services offered by application component 112 via the user interface implemented by user interface component 117, within which the client application renders the information served by the application component. Such client applications may also be referred to as client modules, or simply clients, and may be implemented in a variety of ways. In exemplary embodiments, such client applications can be implemented as any of a myriad of suitable client application types, which range from proprietary client applications (thick clients) to web-based interfaces in which the user agent function is provided by a web server and/or a back-end program (for example, a CGI program). For instance, the user interfaces implemented by user interface component 117 within client applications 142 executing on user systems 140 can be configured to provide various options corresponding to the functionality provided by application component 112 in exemplary embodiments described herein through suitable user interface controls (for example, by way of menu selection, point-and-click, dialog box, or keyboard command). In one general example, the user interfaces may provide “send” or “submit” buttons that allow users of client applications 142 to transmit requested information to application component 112.

In exemplary embodiments, server system 110 can implement the services provided by application component 112 as a non-web client application (such as a mobile application), a web client application, or both to provide the services accessed by user systems 140 within server system 110, and client applications 142 can correspondingly be implemented as non-web client applications, web client applications, or both for operation by users of the user systems to interact with application component 112 and access the services provided thereby. For example, server system 110 can comprise a web server configured to provide a web application for the respective client applications implemented on user systems 140 that are configured to provide web-based user interfaces for utilizing the services provided by the web server. The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user system 140. The web application may be implemented as one or more scripts or programs written in any programming language, such as Java, C, C# or C++, and/or any scripting language, such as Perl, Python, or TCL, as well as combinations of any programming/scripting languages. The server(s) may also include database servers, including without limitation those commercially available from Oracle, Microsoft, Sybase, IBM and the like, which can process requests from database clients running on a user system 140.

In the present exemplary embodiment, correlation analyzer 113 is configured to perform a correlation analysis in which a respective correlation coefficient is, for each secondary survey question that is directed an aspect of the consumer experience with the organization that is identified as having a measurable impact on consumer satisfaction, calculated between the set of response data for the secondary survey question and the set of response data for the primary survey question that addresses the determined primary indicator of consumer satisfaction that represents a level of dependence (in other words, a degree of correlation) between the response data gathered for the two survey questions. Correlation analyzer 113 can be configured to initiate such a correlation analysis, for example, in response to receiving a request transmitted over network 130 by a user operating one of user systems 140 to access server system via the user interface implemented by user interface component 117 within the client application 142 executing on the user systems, and to communicate with database server 122 to access the survey data compiled within survey results database 124b for conducting the analysis.

In exemplary embodiments, the correlation coefficient that correlation analyzer 113 is configured to calculate for each secondary survey question with respect to the primary survey question that addresses the determined primary indicator of consumer satisfaction can be any suitable correlation coefficient for measuring statistical dependence between random variables or two sets of data, such as the Pearson correlation coefficient, distance correlation, Brownian correlation, the randomized dependence coefficient, the correlation ratio, the polychoric correlation, and the coefficient of determination. The most common of these is the Pearson correlation coefficient, which is a measure of the linear correlation or dependence between two variables X and Y and gives a value between +1 and −1 inclusive, where 1 is total positive correlation (that is, the two variables are positively linearly related), 0 indicates a weak linear relationship between the variables, and −1 is total negative correlation (that is, the two variables are negatively linearly related). More particular, the Pearson correlation coefficient is the covariance of the two variables divided by the product of their individual standard deviations and, where applied to a population, is calculated for two random variables X and Y using the following standard formula: Correlation (X,Y)=Cov(X,Y)/(StDev(X)×StDev(Y)), where StDev(X) and StDev(Y) are the population standard deviations (for instance, the standard deviation of random variable X is the average of all values (X−M_{X})², where M_{X} is the average of the values of X in the population), and Cov(X,Y) is the population covariance, which is the average of the product values (X−M_{X})×(Y−M_{Y}) in the population. In this regard, the following are generally accepted guidelines for interpretation of positive values of the Pearson correlation coefficient between two random variables:

### No Relationship: 0.0

### Weak Relationship: 0.0 to 0.3

### Moderate Relationship: 0.3 to 0.7

### Strong Relationship: 0.7 to 1.0

### Perfect Relationship: 1.0

As a simple example of the manner in which correlation analyzer 113 can be implemented to calculate the correlation coefficient indicative of a level of statistical dependence between the response data collected for a secondary survey question that is directed a particular aspect of the consumer experience in a typical transaction with an organization identified as having a measurable impact on consumer satisfaction and loyalty and the response data collected for the primary question that addresses the determined primary indicator of consumer satisfaction using the Pearson correlation coefficient, a hypothetical situation in which the response data for a secondary survey question that is stated as “When I checked in, the receptionist was courteous and friendly. Do you agree or disagree?” is correlated with the response data a primary survey question of “I would recommend this organization to my family and friends. Do you agree or disagree?” can be considered, where the list of possible response choices is provided for both questions as a Likert-type scale in which the possible response options are “1. Strongly disagree”; “2. Disagree”; “3. Neither agree nor disagree”; “4. Agree”; and “5. Strongly agree.”

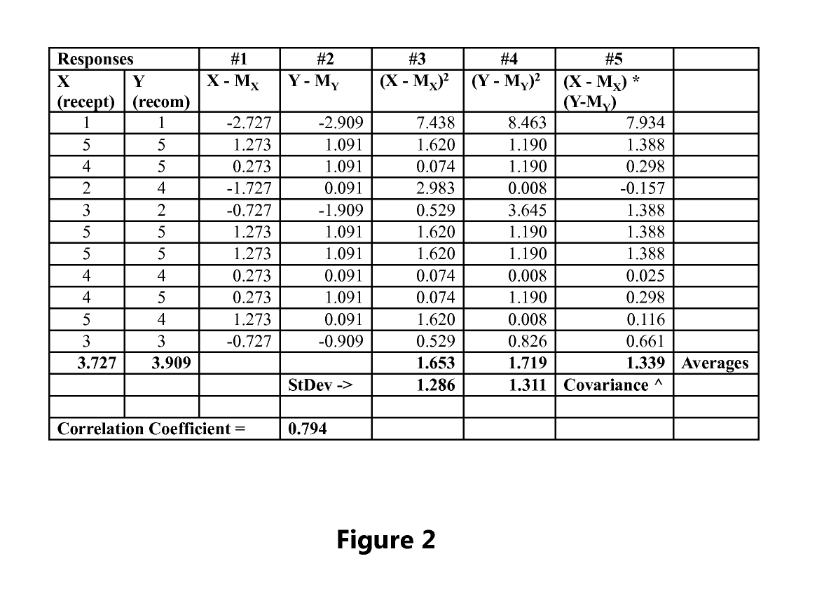

For this example, the random variable X can represent the numeric value of the response data for the secondary receptionist question, and the random variable Y can represent the numeric value of the response data for the primary recommendation question, such that M_{X} represents the average of the values of X, and M_{Y} represents the average of the values of Y. FIG. 2 is a chart illustrating a set of hypothetical response data for a small sample of results for this example and the set calculations that can be performed to determine the Pearson correlation coefficient between the response data for the secondary receptionist question and the response data for the primary recommendation question. As depicted in the chart shown in FIG. 2, column 1 represents the differences between each individual response and the mean of the responses for the secondary receptionist question, column 2 represents the differences between each individual response and the mean of the responses for the primary recommendation question, columns 3 and 4 are the squares of the differences that are used to calculate the standard deviation of the response data for each question, and column 5 is the product of the differences, the average of which is the covariance. Thus, the Pearson correlation coefficient in this example of 0.794 is calculated by dividing the covariance by the product of the two standard deviations. Thus, in the example, according to the generally accepted guidelines for interpretation of positive values of the Pearson correlation coefficient between two random variables discussed above, the calculated Pearson correlation coefficient indicates that the demeanor of the receptionist has a strong effect on whether consumers would recommend the organization.

In exemplary embodiments, as part of the correlation analysis, correlation analyzer 113 can calculate a respective correlation coefficient in such a manner for the response data collected for each secondary survey question of the survey questionnaire with respect to the response data collected for the primary survey question that addresses the determined primary indicator of consumer satisfaction. As a subsequent step in the correlation analysis, correlation analyzer 113 can be configured to, upon calculating the respective correlation coefficient for the response data collected for each secondary survey question, rank the calculated correlation coefficients in descending order, so as to generate a ranking of the secondary survey questions in terms of the level of their relationship with the primary survey question from strongest correlation to weakest correlation. Such a ranking may be used, for example, to determine the key aspects of the consumer experience that drive customer advocacy and loyalty by identifying the secondary survey questions that have the strongest impact on the primary survey question. In this regard, the secondary survey questions that have the strongest impact on the primary survey question may be identified as those for which the respective correlation coefficient that is calculated by the correlation analyzer 113 is at least or greater than a threshold value. As another example, such a ranking may also be used to classify each of the secondary survey questions into a corresponding category according to the strength of the correlation between the secondary survey question and the primary survey question. Such a classification can be performed, for example, by identifying natural breaks between correlations levels in the ordered ranking, and, in exemplary embodiments, may be performed automatically by correlation analyzer 113 as part of the correlation analysis or manually (for example, correlation analyzer 113 can transmit data to a user system 140 being operated by a user to access server system 110 for rendering within the user interface implemented within a client application 142 executing on the user system to thereby allow the user to manually review the ordered ranking to identify natural breaks between the correlation coefficients within the ordered ranking and assign the secondary survey questions into a corresponding categories based thereon). As one non-limiting example, the identified breakpoints in the ordered ranking can be utilized as threshold values for classifying the secondary survey questions into a set of categories separated by the natural breakpoints that comprise “Highly Correlate”; “Moderately Highly Correlate”; “Moderately Correlate”; “Weakly Correlate”; and “None or Negligibly Correlate.” As alternative example, generally accepted guidelines for interpretation of correlation coefficient values, such as those discussed above with reference to Pearson correlation coefficient values, may be utilized to classify the secondary survey questions into such a set of categories. The aspects of the consumer experience that are determined as being key aspects that drive customer advocacy and loyalty based on the identification of the secondary survey questions that have the strongest impact on the primary survey question may provide useful data to the subject organization in terms of the particular aspects of customer experience that would be beneficial for the organization to focus resources on developing.

In exemplary embodiments, the ordered ranking of the calculated correlation coefficients for the secondary survey questions can further be utilized to determine a scoring criteria that can be used to identify the set of the consumer respondents to the survey that would likely be considered the most loyal consumers, or advocates, of the organization that possess a level of loyalty to the organization that would likely motivate consumers to be an advocate on behalf of the organization. In other words, the scoring criteria is determined for the purpose of defining an overall response level that specifies a candidate advocate. For instance, such a scoring criteria can be generated by specifying a minimum response value for the primary survey question and determining a minimum survey response value for each of the secondary survey questions that correspond to the key aspects of the consumer experience that are identified as driving customer advocacy based on a review of the ordered ranking of the calculated correlation coefficients for the corresponding secondary survey questions. The set of secondary survey questions for which a minimum survey response value is set in the scoring criteria may be, for instance, those that are classified as highly or moderately highly correlating to the primary survey question based on identified breakpoints in the ordered ranking of the calculated correlation coefficients. The minimum response value may vary between the secondary survey questions included in the scoring criteria. In one example, where the questionnaire employed a 5-point Likert-type response scale for which answer of 5 is “Strongly Agree” and an answer of 1 is “Strongly Disagree”, the primary survey question may be specified as requiring a minimum response value of 5, the secondary survey questions that are classified as highly correlating may be determined to require a minimum response value of 5, and the secondary survey questions that are classified as moderately highly correlating may be determined to require a minimum response value of 4.

In addition to the ordered ranking of the calculated correlation coefficients for the secondary survey questions, any other suitable information may be utilized in determining the scoring criteria such as, for example, information pertaining to the particular industry within which the organization for which the survey was conducted operates. Moreover, in exemplary embodiments, the specification of such a scoring criteria may include additional criteria such as an indication of whether a response is required to be included in the completed questionnaire for each of the secondary survey questions that correspond to the key aspects of the consumer experience that are identified as driving customer advocacy when the scoring criteria is applied to the survey response data to determine candidate advocates for the subject organization. For example, in a particular questionnaire, all questions may not require an answer from the consumer respondents, as some may not apply with regard to the experience with the organization for every consumers, and some questionnaires may not require certain questions to be answered and allow respondents to skip these questions.

In exemplary embodiments, data describing such a scoring criteria may be generated automatically by correlation analyzer 113 as part of the correlation analysis or manually (for example, a user operating a user system 140 may, upon manually reviewing the ordered ranking within the user interface implemented within a client application 142 executing on the user system, utilize suitable user interface elements implemented within the user interface to input and transmit a specification of the scoring criteria to server system 110). In exemplary embodiments, upon data describing such a scoring criteria being generated by or otherwise received by application component 112, the application component can operate to store the data describing the scoring criteria (for example, locally within server system 110 or by communicating with database server 122 to save the scoring criteria data within advocate information file 124d).

In this regard, in exemplary embodiments, advocate identifier 114 of application component 112 can be configured to perform an automated analysis of the survey response data to identify consumer respondents that qualify as candidate advocates by accessing the data describing the determined scoring criteria, communicating with database server 122 to access the survey data compiled within survey results database 124b, and evaluating the completed questionnaire data in the respective information record for each of the consumer respondents to determine whether the responses provided in the corresponding completed questionnaire satisfies the minimum scoring criteria. For each respective information record included within survey results database 124b for which the completed questionnaire data is determined by advocate identifier 114 to satisfy the minimum scoring criteria, the advocate identifier can determine the consumer respondent that completed the corresponding questionnaire to be deemed a candidate advocate of the subject organization. In this regard, advocate identifier 114 can be configured to generate data describing a list of the consumer respondents that are deemed to be candidate advocates of the subject organization by communicating with database server 122 to access the data pertaining to each sampled respondent compiled within a respective information record within survey respondent information database 124c that is associated with a respective information record within survey results database 124b for which advocate identifier 114 has determined the completed questionnaire data to satisfy the minimum scoring criteria. The information included in the data describing the list of the consumer respondents that are deemed to be candidate advocates can include, for example, the names and contact information, such as email addresses, of the respondents.

In exemplary embodiments, advocate identifier 114 can be further configured to communicate with database server 122 to save the data describing the list of the consumer respondents that are deemed to be candidate advocates within advocate information file 124d. Advocate identifier 114 can also be configured to, in exemplary embodiments, transmit data describing the list of the consumer respondents that are deemed to be candidate advocates to a user system 140 being operated by a user to access server system 110 for rendering a presentation of the list of identified candidate advocates within the user interface implemented within a client application 142 executing on the user system (for example, by displaying the list of identified candidate advocates along with contact information and other relevant information for the identified candidate advocates within a GUI implemented by user interface component 117 within the client application) to thereby allow the user to review the information describing the identified candidate advocates in the rendered list.

In the present exemplary embodiment, advocate quotient calculator 115 can be configured to perform an automatic calculation of an “advocacy quotient” for the subject organization by determining a total quantity (or sample size) of consumer respondents for the survey (that is, the overall number of information records within survey results database 124b respectively associated with sampled respondents, which may be determined by communicating with database server 122 to access survey results database 124b and perform a count of the number of information records for questionnaire responses that have been compiled within survey results database 124b or receive an indication of this quantity if the quantity has already been determined and such an indication was stored within the survey results database after the determination was made), accessing the data describing the list of the consumer respondents that are deemed to be candidate advocates (for example, by communicating with database server 122 to access this information within advocate information file 124d) and analyzing this information to determine a quantity of the consumer respondents that are deemed to be candidate advocates (that is, the number of information records within survey results database 124b respectively associated with sampled respondents for which advocate identifier 114 has determined the completed questionnaire data to satisfy the minimum scoring criteria), calculating a percentage of the total quantity of consumer respondents for the survey that have been deemed to be candidate advocates by advocate identifier 114, and applying an index to the calculated percentage to thereby translate the percentage of the sample population that have been deemed to be candidate advocates to the advocacy quotient. In some exemplary embodiments, advocate quotient calculator 115 can be further or alternatively configured to perform an automatic calculation of a respective advocacy quotient for each of multiple different business segments for the subject organization.

In exemplary embodiments, advocate quotient calculator 115 can be further configured to communicate with database server 122 to save an indication of the calculated advocacy quotient for the organization within advocate information file 124d. Advocate quotient calculator 115 can also be configured to, in exemplary embodiments, transmit data providing an indication of the calculated advocacy quotient to a user system 140 being operated by a user to access server system 110 for rendering a presentation of the advocacy quotient within the user interface implemented within a client application 142 executing on the user system (for example, by displaying the determined advocacy quotient within a GUI implemented by user interface component 117 within the client application) to thereby allow the user to review this information. The advocacy quotient that is calculated for organization may be used for various purposes in various embodiments. For example, where the determined advocacy quotient for the organization (or the respective advocacy quotient for a business segment for the organization) is considered to be outstanding within the industry of the organization, the organization may wish to use the advocacy quotient for marketing or promotional purposes. Such an advocacy quotient for an organization may be considered outstanding for the organization's industry, for instance, when the quotient places the organization within a percentile ranking that, in comparison with other organizations collectively within the industry, is considered exceptional for the industry.

As discussed above, in exemplary embodiments of the present invention, by performing a correlation analysis of survey results data to identify the secondary survey questions that have the strongest impact on or correlation to the answer to primary survey question that addresses the determined primary indicator of consumer satisfaction, the key aspects of the entire consumer experience that drive customer advocacy can be identified and the survey results data can be analyzed using a scoring criteria that is defined in view of these identified key aspects to thereby identify the set of the consumer respondents to the survey that would likely be the most loyal consumers, or advocates, of the organization that, rather than likely possessing a general level of loyalty to the organization, possess a level of loyalty to the organization that would likely motivate consumers to be an advocate on behalf of the organization can be identified. In this regard, by performing the identification of candidate advocates based on identified key aspects of the entire consumer experience that drive customer advocacy as described above rather than merely a single question that simply asks how satisfied a consumer was with their experience with an organization or how likely a consumer would be recommend the organization, exemplary embodiments can be implemented to provide a level of assurance that each of the identified candidate advocates is a consumer that is not only satisfied with their overall experience, but also did not encounter any significant aspects during their experience that they considered to be less than favorable (and, thus, would be less likely to bring any such “less than favorable” aspects to the attention of someone to whom they may recommend the organization in a manner that would qualify the recommendation to an extent).

In this regard, in the present exemplary embodiment, advocate endorsement solicitor 116 is configured to provide a mechanism by which an organization can take advantage of such an identified list of candidate advocates that have been determined, among those consumers who have an indicated a general level of loyalty to the organization that would likely motivate the consumer to provide recommendations or endorsements for the organization, to be least likely to include negative qualifying statements regarding the organization in their recommendations by soliciting and facilitating public promotion of the organization from the identified candidate advocates. More specifically, advocate endorsement solicitor 116 can be configured to communicate with database server 122 to access the data describing the list of the consumer respondents that are deemed to be candidate advocates within advocate information file 124d and, based on this retrieved information, automatically generate a respective endorsement solicitation request to be sent to each of the respondents identified within the candidate advocate list in which the respondent is requested to visit or access one or more consumer feedback or social media websites or applications and leave feedback about their consumer experience with the organization. Upon the respective endorsement solicitation request being sent to each of the respondents identified within the candidate advocate list, the website(s) or application(s) referenced in the request can be monitored to assess whether the endorsement solicitation requests have resulted in an increase in public promotion of the organization from the identified candidate advocates. In exemplary embodiments, advocate endorsement solicitor 116 (or another component of server system 110) can be configured to automatically perform such monitoring and provide notifications the subject organization regarding impact on public promotion of the organization based on an assessment of collected monitoring data.

In one example, the respective endorsement solicitation request that is generated by advocate endorsement solicitor 116 for each respondent identified within the data describing the list of identified candidate advocates can be, for instance, an email message that is automatically generated based on a pre-configured message template that is maintained locally within or otherwise accessible by server system 110 and personalized for the respondent by addressing the message to the email address of the respondent included within the data describing the list of identified advocates (for example, by specifying the respondent's email address as the recipient within the header portion of the message), as well by inserting information specific to the respondent in corresponding predetermined data fields defined within a message body portion of the template (for example, the body portion of the email message template may include a field within a salutation section of the message body in which the respondent's name is inserted). It should be noted, of course, that email is a non-limiting example of a medium that may be utilized for sending endorsement solicitation requests to each of the respondents identified within the candidate advocate list and that, in other exemplary embodiments, any suitable communication medium may be utilized for sending endorsement solicitation requests to the respondents identified as candidate advocates.

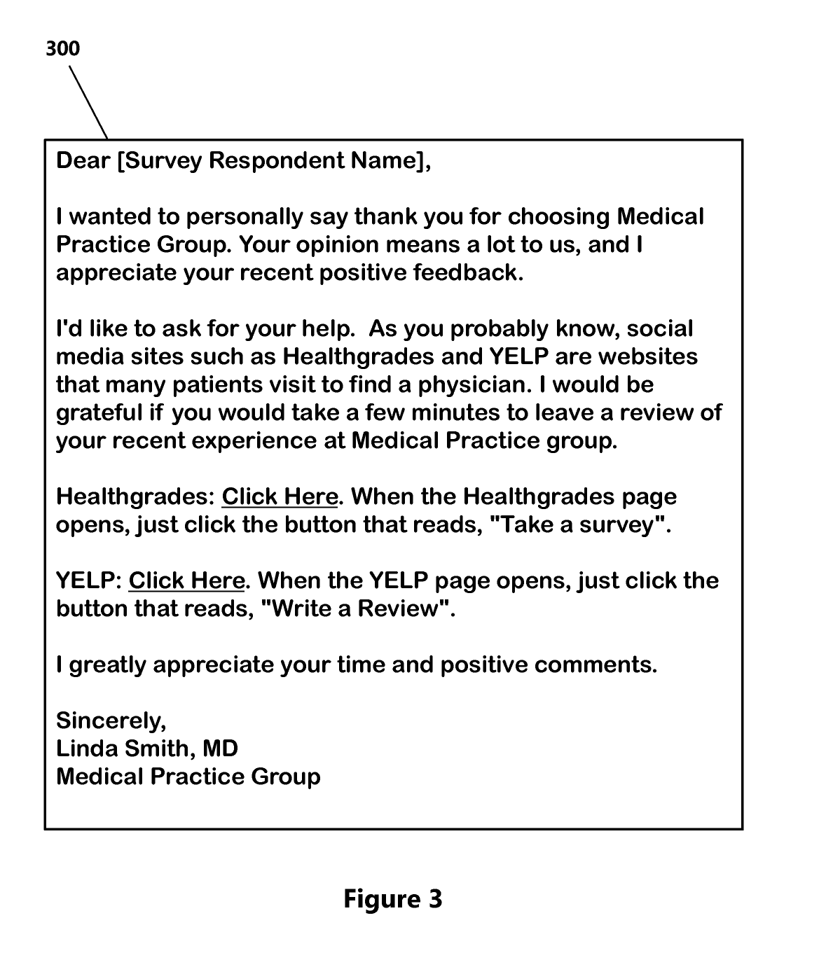

In the present example, the content of the message body portion of the email message template can comprise, for example, text that expresses appreciation for the respondent's decision to conduct business with the organization and complete the survey questionnaire, and for providing positive feedback within their questionnaire response along with a request for the respondent to visit or access one or more consumer feedback or social media websites or applications and leave feedback about their consumer experience with the organization, such as an endorsement or a positive review. In this regard, the particular websites or applications referenced within the message template can be determined, for instance, based on relevance to the industry of the organization and/or preferences of the organization and may include, as non-limiting examples, Yelp, Facebook, Twitter, Google+, industry specific social media sites such as Healthgrade, organization websites, industry blogs, relevant message boards, and the like. In this regard, the content of the message body portion of the template can further comprise, for instance, hyperlinks or other references that can accessed by the message recipient to be directed to the particular websites or applications referenced within the message template for leaving feedback. A non-limiting example of a body portion 300 of an exemplary endorsement solicitation request message template is illustrated in FIG. 3.

In exemplary embodiments, advocate endorsement solicitor 116 can be configured to, upon generating the email message for each respondent identified within the data describing the list of identified candidate advocates based on the pre-configured message template, send the email message generated for each respondent identified as a candidate advocate from server system 110 to the recipient address for the respondent included in the generated message via a computer network such as, for example, network 130. In some exemplary embodiments, advocate endorsement solicitor 116 may be configured to send the email message generated for each respondent identified as a candidate advocate at a set time or after set period of time has passed from the point in time at which the questionnaire was completed by the respondent. In a specific example, to initiate the message flow, advocate endorsement solicitor 116 can be configured to direct an email client application executing on server system 110 to cause an outbound messaging gateway, which may be owned by, operated by, or otherwise associated with the providers of the server system, to send the respective email message generated for each respondent identified as a candidate advocate directed to the message recipient identified in the header portion of the generated message. The email message sent to the respective email address for each respondent will then be routed to, delivered to, and stored at an inbound messaging gateway for the message recipient and may be retrieved therefrom by the respondent through operation of an email client application executing on a client system being operated by the particular respondent.

In exemplary embodiments, server system 100 and the message recipient respondents can each utilize any of a myriad of email clients, which range from proprietary email clients (thick clients) to web-based interfaces that retrieve email messages in which the user agent function is provided by a Web server and/or a back-end program (for example, a CGI program) running on the same system as the inbound message gateway (which may be, for example, a destination the Simple Mail Transfer Protocol (SMTP) host), and each messaging gateway may comprise a general-purpose messaging gateway, also known as a Message Transfer Agent (MTA), mail relay, email relay, email router, Simple Mail Transfer Protocol (SMTP) server, QMQP server, or email gateway, which is specially programmed to perform email message routing functions. In practical exemplary embodiments, there may be any number of outbound, inbound, and intermediate messaging gateways, and the use of any number of such elements is contemplated.

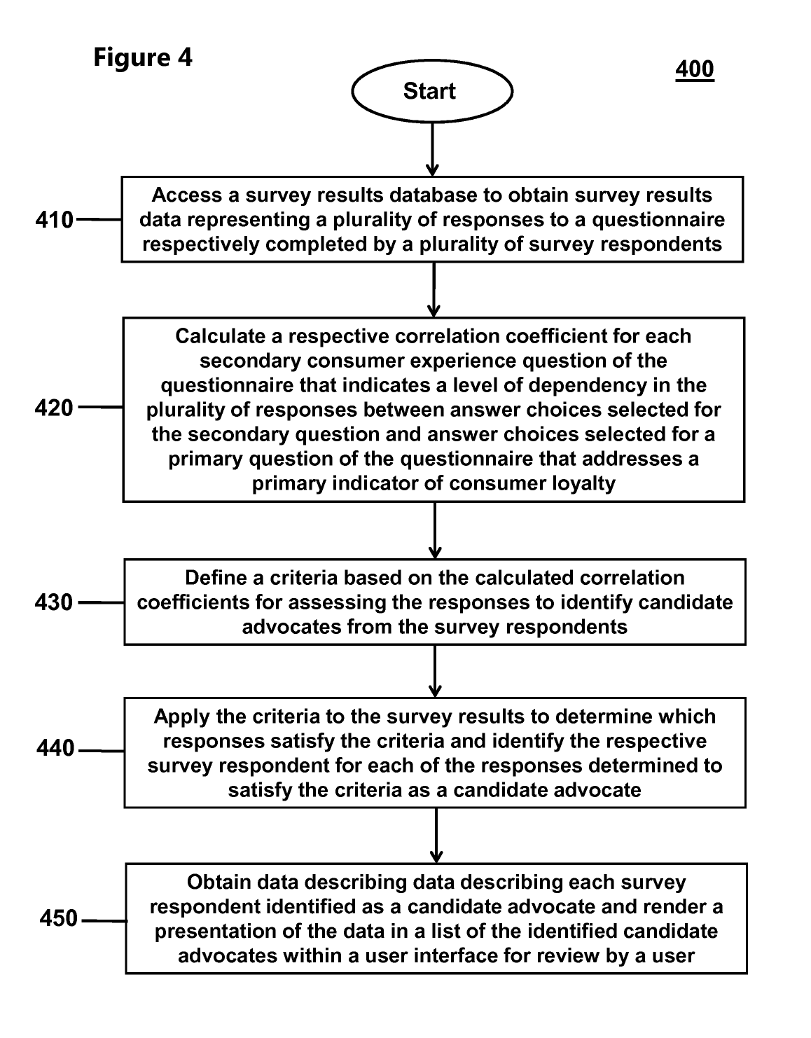

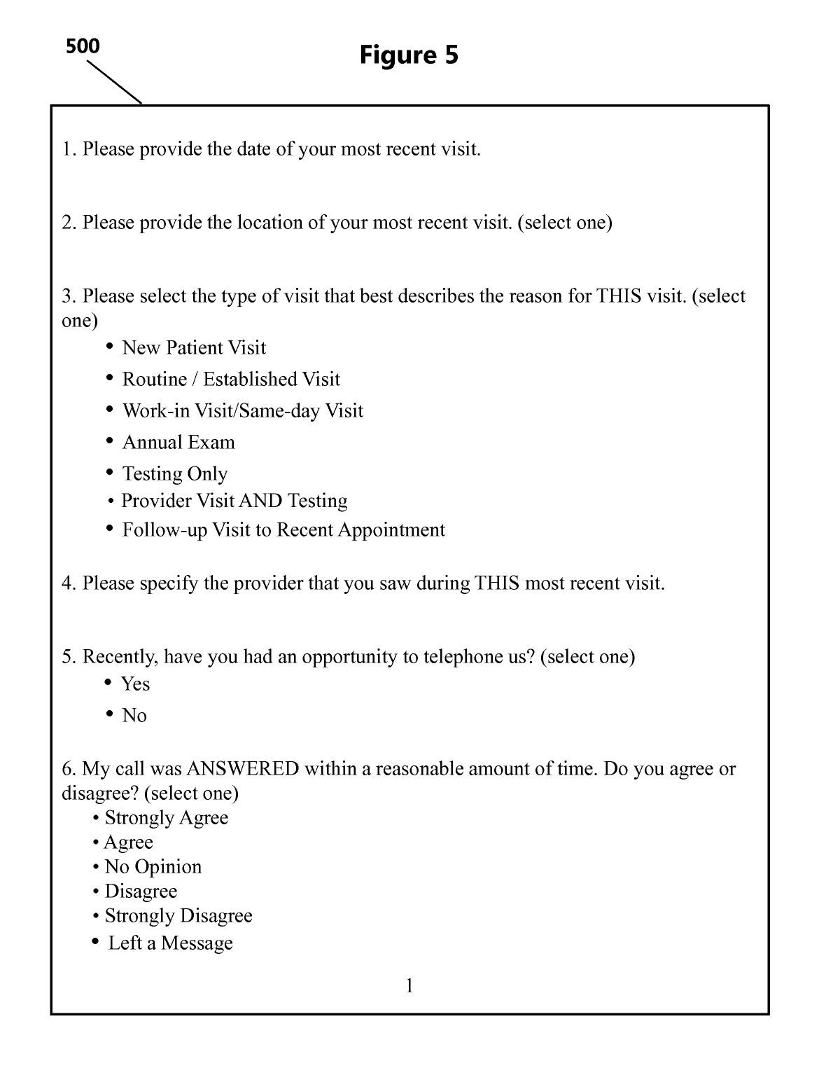

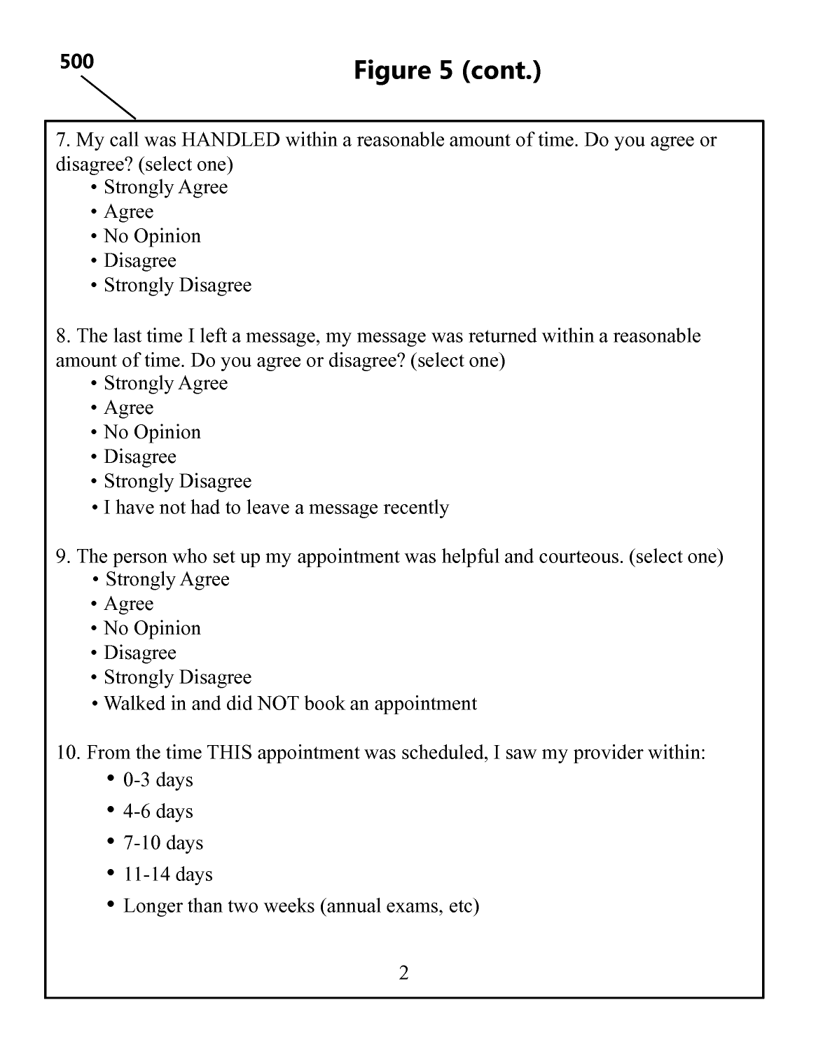

Referring now to FIG. 4, an exemplary embodiment of a process 400 for analyzing consumer feedback to identify candidate advocates for an organization in accordance with the present invention is illustrated. Process 400 may be performed, for example, by components of an advocate identification system implemented within exemplary operating environment 100 described above with reference to FIG. 1. In exemplary process 400, at block 410, a set of survey results data is obtained by accessing a survey results database that is maintained within a data store. The set of survey results data obtained at block 410 represents a plurality of responses to a questionnaire that, as part of a survey implemented and conducted by or on behalf of the organization, have each been completed by a respective consumer respondent of a plurality of consumer respondents based on a transaction the consumer respondent has engaged in with the organization, where the questionnaire comprises a primary question that addresses a primary indicator of consumer loyalty and a plurality of secondary questions each addressing a corresponding aspect of consumer experience during transactions with the organization. Each of the primary question and the secondary questions of the questionnaire is constructed with a closed-ended ordinal response scale having an ordered list of answer choices that are each assigned a numeric value along a continuum corresponding to the response scale for the question and from which one answer choice is selected to answer the question. The set of survey results data obtained at block 410 is then processed at block 420 to calculate a respective correlation coefficient for each secondary question that indicates a level of dependency between the numeric values assigned to the answer choices selected in the plurality of responses for the secondary question and the numeric values assigned to the answer choices selected in the plurality of responses for the primary question.

At block 430 in the present exemplary embodiment, the respective correlation coefficients calculated for the secondary questions at block 420 are evaluated to define a criteria for assessing the plurality of responses to identify candidate advocates from the plurality of consumer respondents. More specifically, a set of secondary questions of the plurality of secondary questions for which the respective correlation coefficients are greater than a threshold value is determined, and the criteria is defined in view of the respective correlation coefficients to specify which of the answer choices for the set of secondary questions can be selected in any given response to the questionnaire for the response to satisfy the criteria. Next, at block 440, the criteria that is defined at block 430 is applied to the survey results data representing the plurality of responses to determine which of the responses satisfy the criteria, and the respective consumer respondent for each of the responses that is determined to satisfy the criteria is identified as a candidate advocate for the organization. Finally, at block 450, data describing each consumer respondent that is identified as a candidate advocate at block 440 is obtained by accessing a survey respondent information database that is maintained within the data store and transmitted to a client application executing on a user system for rendering a presentation of the data describing the candidate advocates in a list of the identified candidate advocates within a user interface implemented at the client application for review by a user. The presentation of the list of identified candidate advocates may include, for example, names and contact information of the consumer respondents that are identified as candidate advocates for the organization.

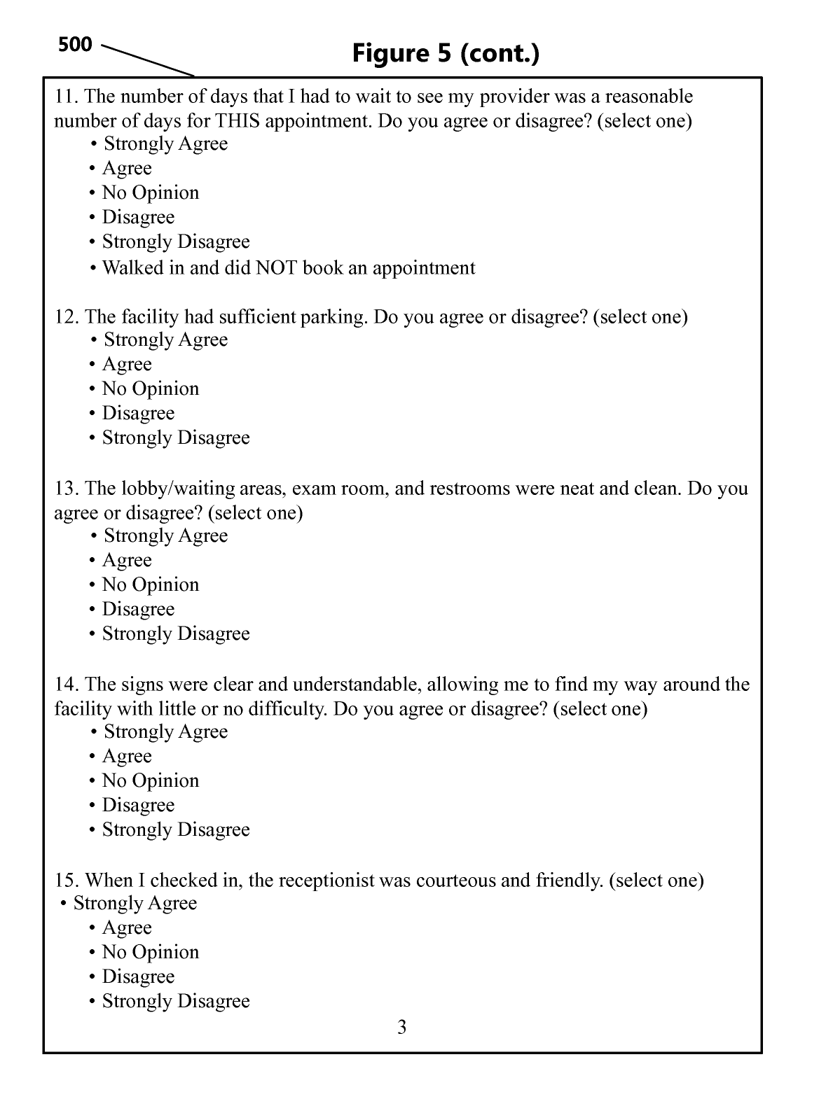

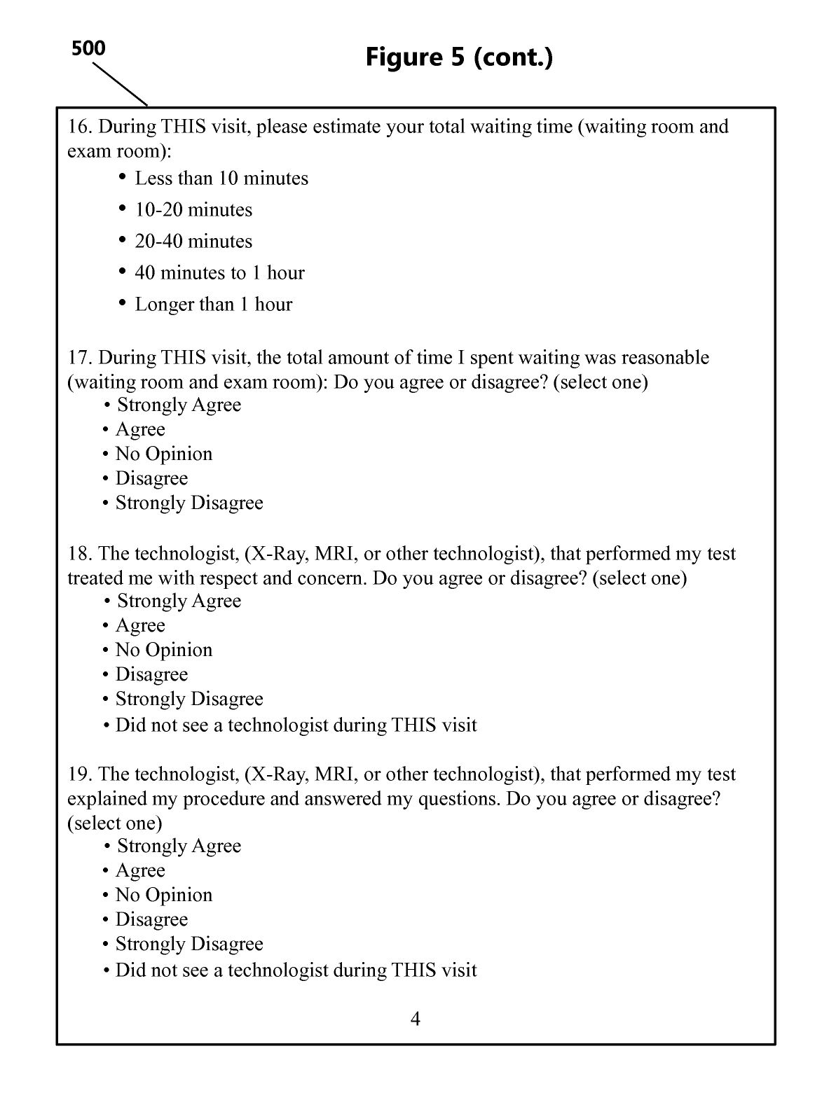

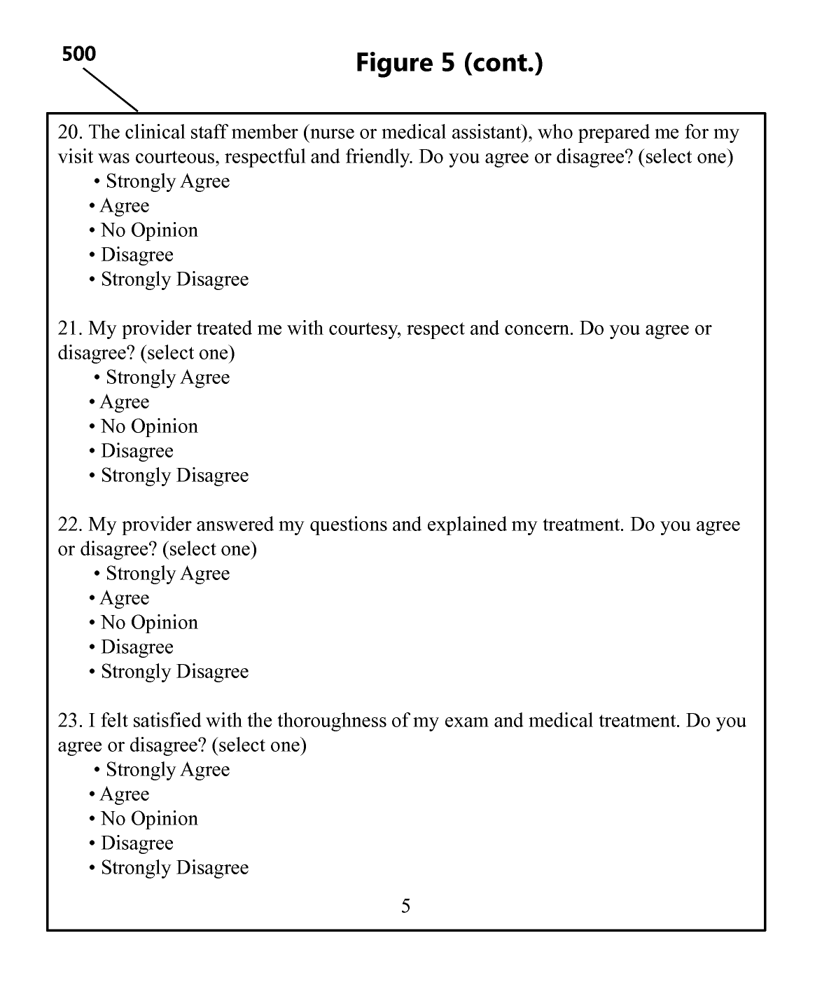

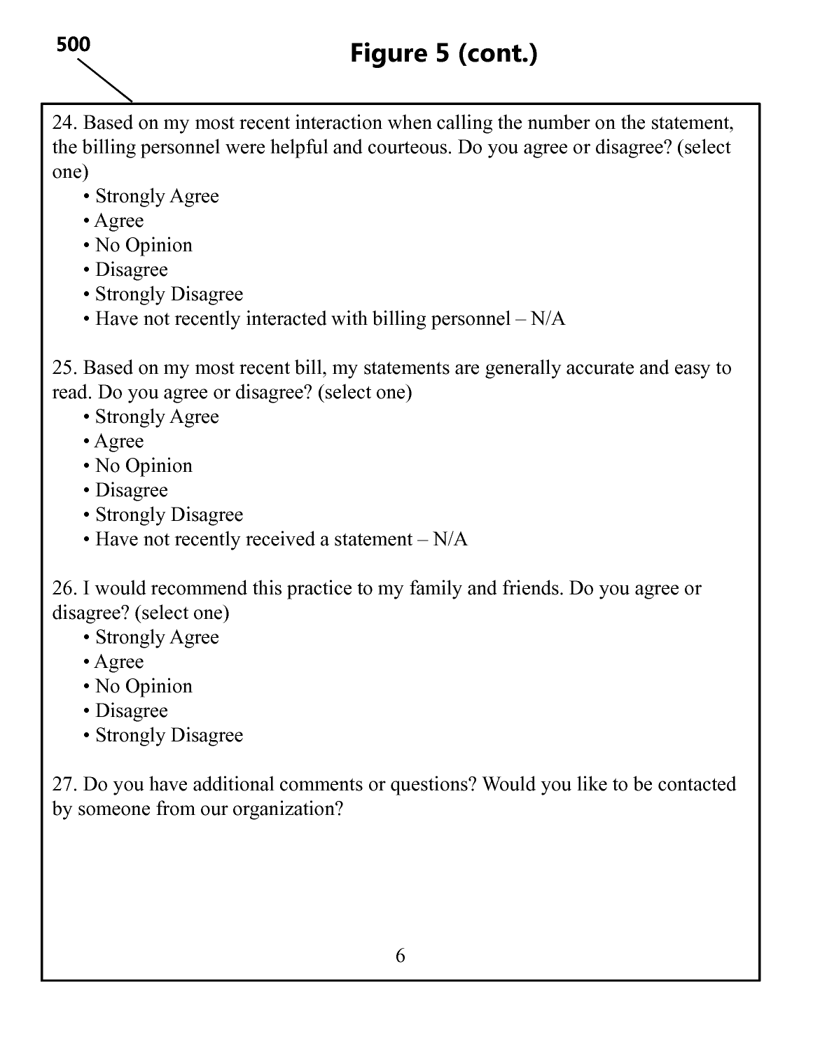

For illustrative purposes, a non-limiting example of an implementation of an exemplary embodiment of the present invention will now be described with reference to the example survey questionnaire 500 illustrated in FIG. 5. While questionnaire 500 has been constructed for a physician practice to assess the experiences of patient consumers who have received services from the physician practice in the present example, exemplary implementations of the present invention should not considered as being limited to application for any particular type of organization. In the example depicted in FIG. 5, questionnaire 500 is comprised of a series of 29 “standard” questions for assessing the experience of each consumer respondent throughout the process of visiting the practice and which address the following aspects of a patient's visit: type of visit, telephone service, appointment scheduling, facility, reception, technologist/ancillary service, provider exam/interaction, billing/invoicing, comments, and demographic information. More specifically, questionnaire 500 includes a set of general questions regarding the patient's visit (questions 1-4), a set of questions regarding telephone correspondence with the practice (questions 5-8), a set of questions regarding appointment scheduling (questions 9-11), a set of questions regarding the facilities at the practice location (questions 12-14), a set of questions regarding reception at the practice location (questions 15-17), a set of questions regarding interactions with a technologist (questions 18-19), a set of questions regarding interactions with a physician (questions 20-23), a set of questions regarding the billing department for the practice (questions 24-25), a question that addresses the primary indicator of patient satisfaction that is determined to represent whether a patient possesses a level of loyalty to the practice that would likely motivate the patient to be an advocate on behalf of the practice (question 26, which is provided in conjunction an opportunity for the patient respondent to provide additional comments or questions in question 27), and a set of questions regarding the patient (questions 28-29) provided along with a request for the patient respondent's name and contact information (labeled with the number 30).

In the present example, questions 5-25 have been constructed based on a review of the business process and operations of the physician practice that is conducted to document noteworthy aspects of the typical chronological path of experiences and interactions of a patient in a typical transaction for obtaining healthcare services from the practice and identify the key touch points related to aspects of this transaction path that, in view of relevant industry standards and guidelines, have a measurable impact on patient satisfaction and loyalty, while questions 1-4 and 27-30 are additional questions that are not directed to aspects of the consumer experience. Questions 27-30 will not be involved in the correlation analysis of the present example and, thus, are not required to be formatted with closed-ended ordinal response scales. On the other, as questions 5-26 will be involved in the correlation analysis, each of these questions is a formatted as a closed-ended question that each respondent patient answers in a set format by selecting an answer from a given number of mutually-exclusive and collectively-exhaustive standardized answer options.

In the present example, some of the closed-ended questions, such as questions 11, 18, and 19, have been constructed with an “opt-out” answer, as these questions may not be applicable to all patient respondents. The questionnaire may include other questions that may not be presented to all patients. For example, question 7 may not be presented to certain patient respondents that, for example, booked an appointment after a previous appointment and, thus, did not call into the office. Most of the closed-ended questions 5-26 are formatted to be answered on a five-point Likert-type scale in which respondents specify their level of agreement or disagreement on a agree-disagree scale for each Likert item, with numeric values assigned to possible answer choices according to the following format: “Strongly disagree: 1”; “Disagree: 2”; “No opinion: 3”; “Agree: 4”; and “Strongly agree: 5.”

Once the survey of the present example has been conducted and the results have been compiled, the questionnaire responses are assessed to filter out the responses that are deemed to not have been completed. For instance, responses that are deemed to be completed may be those for which the respondent answered questions through and including question 26. In one example, the number of questionnaire responses received from patient respondents may be in a range from 70,000 to 80,000, and, if the survey has a 95 percent completion rate, the number completed questionnaire responses received may be in a range from 66,500 to 76,000.

The completed responses are then used to perform a correlation analysis with respect to response elements of the survey data collected for each of the secondary questions in the questionnaire directed the aspects of the entire patient experience in a typical transaction with the physician practice that are identified as having a measurable impact on patient satisfaction (questions 5-25) and loyalty relative to the survey data response elements collected for the primary question that addresses the determined primary indicator of consumer satisfaction (question 26). More specifically, the correlation analysis is performed to calculate, for each secondary survey question, a respective correlation coefficient between the set of response data for the secondary survey question and the set of response data for the primary survey question that represents a level of dependence between the response data gathered for the two survey questions.

In the present example, the secondary questions are, based on the respective correlation coefficient calculated for each secondary question, ranked according to their degrees of correlation to the primary survey question (in other words, according to their impact on the overall satisfaction level of patients as indicated by the respective correlation coefficients) in descending order, so as to generate a ranking of the secondary survey questions in terms of the level of their relationship with the primary survey question from strongest correlation to weakest correlation. The ordered ranking is then analyzed to classify each of the secondary survey questions into a corresponding category according to the strength of the correlation between the secondary survey question and primary survey question 26. In the present example, the secondary survey questions are classified based on the ordered ranking into a set of question categories that comprise “Highly Correlate”; “Moderately Highly Correlate”; “Moderately Correlate”; “Weakly Correlate”; and “None or Negligibly Correlate,” and this classification then utilized to determine a scoring criteria that can be used to identify the set of the patient respondents for the survey that would be considered candidate advocates of the physician practice. In particular, secondary survey questions that are deemed to “Highly Correlate” to the primary survey question can be assigned a minimum survey response value of 5 (“Strongly agree”) in the scoring criteria, secondary survey questions that are deemed to “Moderately Highly Correlate” to the primary survey question can be assigned a minimum survey response value of 4 (“Agree”) in the scoring criteria, and secondary survey questions that deemed to “Moderately Correlate,” “Weakly Correlate,” and “None or Negligibly Correlate” to the primary survey question are not assigned a minimum survey response value in the scoring criteria. The scoring criteria also includes an indication of whether a response is optional or required to be included in the completed questionnaire for each of the secondary survey questions that are deemed to highly correlate or moderately highly correlate to the primary survey question.

In the scoring criteria of the present example, primary question 26, which addresses the determined primary indicator of consumer satisfaction is assigned a minimum survey response value of 5, and, based on the correlation analysis, questions 21-23 are classified as highly correlating to the primary survey question and assigned a minimum survey response value of 5, and questions 7, 9, 13-15, and 17-20 are classified as moderately highly correlating to the primary survey question and assigned a minimum survey response value of 4. Questions 7, 9, 14, 18, and 19 are further specified in the scoring criteria as not requiring an answer to be selected by the respondent. The determined scoring criteria is then utilized to perform an analysis of the survey response data to identify patient respondents that qualify as candidate advocates of the physician practice by evaluating the completed questionnaire data in the survey results for each of the patient respondents to determine whether the responses provided in the corresponding completed questionnaire satisfies the minimum scoring criteria. The process of applying the determined scoring criteria to the data for each completed questionnaire in the survey results to identify candidate advocates among the patient respondents in the present example can be outlined as follows:

Step 1: The completed questionnaire must have the patient name and email address specified in field 30. If no patient name or email address is provided, the respondent is deemed to not qualify as a candidate advocate. If the patient name and email address are specified, proceed to Step 2.

Step 2: The completed questionnaire must have a response value of 5 (“Strongly agree”) for the primary survey question 26. If no answer is provided or the response value is less than 5, the respondent is deemed to not qualify as a candidate advocate. If the response value is 5, move to Step 3.

Step 3: Each of the secondary survey questions for which an answer is required to be provided and a minimum survey response value is assigned in the scoring criteria must have an answer that meets the minimum survey response value assigned to the question. For instance, the completed questionnaire must have a response value of 4 (“Agree) or 5 (“Strongly agree”) for the secondary survey question 13. If no answer is provided or the response value is less than 4, the respondent is deemed to not qualify as a candidate advocate. Similarly, the completed questionnaire must have a response value of 5 (“Strongly agree”) for the secondary survey question 21. If no answer is provided or the response value is less than 5, the respondent is deemed to not qualify as a candidate advocate. If all of the secondary survey questions included in the scoring criteria for which an answer is required are answered in the completed questionnaire with response values that meet the minimum survey response values respectively assigned to the questions, proceed to Step 4.

Step 4: Each of the secondary survey questions for which an answer is specified as being optional and a minimum survey response value is assigned in the scoring criteria must either not be answered or have an answer that meets the minimum survey response value assigned to the question. For instance, the completed questionnaire must either have not been answered or have a response value of 4 (“Agree) or 5 (“Strongly agree”) for the secondary survey question 7. If an answer is provided, but the response value is less than 4, the respondent is deemed to not qualify as a candidate advocate. If all of the secondary survey questions included in the scoring criteria for which an answer is specified as being optional are either not answered or answered in the completed questionnaire with response values that meet the minimum survey response values respectively assigned to the questions, proceed to Step 5.

Step 5: The patient respondent for the completed questionnaire is deemed to be a candidate advocate of the physician practice, and data pertaining to the identified candidate advocate is stored in a database. In the present example, the particular data that is stored for each patient respondent identified as a candidate advocate includes the patient's name and email address, the name of the physician provider for the patient's visit, and the date when the patient respondent submitted the completed questionnaire. As described above, the data pertaining to the patient respondents that are identified as candidate advocates may be utilized by the organization in various manners, such as to maintain a list of such identified candidate advocates, determine a value that corresponds to a percentage of total consumers that are identified as candidate advocates, and provide a streamlined approach for soliciting and facilitating public promotion from the identified candidate advocates.

Aspects of exemplary embodiments of the present invention described herein can be implemented using one or more program modules and data storage units. As used herein, the term “modules”, “program modules”, “components”, “systems”, “tools”, “utilities”, and the like include routines, programs, objects, components, data structures, and instructions, or instructions sets, and so forth that perform particular tasks or implement particular abstract data types. As can be appreciated, the modules refer to computer-related entities that can be implemented as software, hardware, firmware and/or other suitable components that provide the described functionality, and which may be loaded into memory of a machine embodying or embodied within an exemplary embodiment of the present invention. Aspects of the modules may be written in a variety of programming languages, such as C, C++, Java, etc. The functionality provided by modules used for aspects of exemplary embodiments described herein can be combined and/or further partitioned.

As used herein, the terms “data storage unit,” “data store”, “storage unit”, and the like can refer to any suitable memory device that may be used for storing data, including manual files, machine readable files, and databases. The modules and/or storage units can all be implemented and run on the same computing system (for example, the exemplary computer system illustrated in FIG. 6 and described below) or they can be implemented and run on different computing systems. For example, one or more modules can be implemented on a personal computer operated by a user while other modules can be implemented on a remote server and accessed via a network.

In exemplary embodiments, the program modules utilized in exemplary embodiments of the present invention can be configured for incorporation within any suitable computing environment as a plug-in, add-on, or extension. As used herein, the term “plug-in” can refer to a software application or module program, or one or more computer instructions, which may or may not be in communication with other software applications or modules, that interacts with a host application to provide specified functionality, and which may include any file, image, graphic, icon, audio, video, or any other attachment. In other exemplary embodiments, the program modules can be implemented within a standalone program that is run as a separate computer process, a portable application, as a native component of an automated customer satisfaction research tool, as part of a software bundle, or any other suitable implementation.

In the preceding description, for purposes of explanation, numerous specific details are set forth in order to provide a thorough understanding of the described exemplary embodiments.

Nevertheless, one skilled in the art will appreciate that many other embodiments may be practiced without these specific details and structural, logical, and electrical changes may be made.

Some portions of the exemplary embodiments described above are presented in terms of algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Exemplary embodiments of the present invention can be realized in hardware, software, or a combination of hardware and software. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: (a) conversion to another language, code or, notation; and (b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allows a computer system to read such computer readable information.

FIG. 6 is a block diagram of an exemplary computer system 600 that can be used for implementing exemplary embodiments of the present invention. Computer system 600 includes one or more processors, such as processor 604. Processor 604 is connected to a communication infrastructure 602 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary computer system 600 can include a display interface 608 that forwards graphics, text, and other data from the communication infrastructure 602 (or from a frame buffer not shown) for display on a display unit 610. Computer system 600 also includes a main memory 606, which can be random access memory (RAM), and may also include a secondary memory 612. Secondary memory 612 may include, for example, a hard disk drive 614 and/or a removable storage drive 616, representing a floppy disk drive, a magnetic tape drive, an optical disk drive, etc. Removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, removable storage unit 618 includes a computer usable storage medium having stored therein computer software and/or data.

In exemplary embodiments, secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (that is, channel) 626. Channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface including a wired network or a wireless network that allow a computer to read such computer readable information.

Computer programs (also called computer control logic) are stored in main memory 606 and/or secondary memory 612. Computer programs may also be received via communications interface 624. Such computer programs, when executed, can enable the computer system to perform the features of exemplary embodiments of the present invention as discussed herein. In particular, the computer programs, when executed, enable processor 604 to perform the features of computer system 600. Accordingly, such computer programs represent controllers of the computer system.

While the invention has been described in detail with reference to exemplary embodiments, it will be understood by those skilled in the art that various changes and alternations may be made and equivalents may be substituted for elements thereof without departing from the scope of the invention as defined by the appended claims. In addition, many modifications may be made to adapt a particular application or material to the teachings of the invention without departing from the essential scope thereof.

Variations described for exemplary embodiments of the present invention can be realized in any combination desirable for each particular application. Thus particular limitations, and/or embodiment enhancements described herein, which may have particular limitations need be implemented in methods, systems, and/or apparatuses including one or more concepts describe with relation to exemplary embodiments of the present invention.

Therefore, it is intended that the invention not be limited to the particular embodiments disclosed herein for carrying out this invention, but that the invention will include all embodiments falling within the scope of the present application as set forth in the following claims, wherein reference to an element in the singular, such as by use of the article “a” or “an” is not intended to mean “one and only one” unless specifically so stated, but rather “one or more.” Moreover, no claim element is to be construed under the provisions of 35 U.S.C. §112, sixth paragraph, unless the element is expressly recited using the phrase “means for” or “step for.” These following claims should be construed to maintain the proper protection for the present invention.

What is claimed is:

1. A method for analyzing consumer feedback to identify candidate advocates for an organization, the method comprising:
accessing a survey results database stored within a data store to obtain a set of survey results data representing a plurality of responses to a questionnaire that have each been completed by a respective consumer respondent of a plurality of consumer respondents based on a transaction the consumer respondent has engaged in with the organization, where the questionnaire comprises a primary question that addresses a primary indicator of consumer loyalty and a plurality of secondary questions each addressing a corresponding aspect of consumer experience during transactions with the organization, and where each of the primary question and the secondary questions is constructed with a closed-ended ordinal response scale having an ordered list of answer choices that are each assigned a numeric value along a continuum corresponding to the response scale for the question and from which one answer choice is selected to answer the question;
automatically processing the survey results data to calculate a respective correlation coefficient for each secondary question that indicates a level of dependency between the numeric values assigned to the answer choices selected in the plurality of responses for the secondary question and the numeric values assigned to the answer choices selected in the plurality of responses for the primary question;
evaluating the respective correlation coefficients calculated for the secondary questions to define a criteria for assessing the plurality of responses to identify candidate advocates from the plurality of consumer respondents, where the criteria specifies, for a set of secondary questions of the plurality of secondary questions for which the respective correlation coefficients are greater than a threshold value, which of the answer choices for the set of secondary questions can be selected in a given response to the questionnaire for the response to satisfy the criteria; and
automatically evaluating the survey results data to determine which of the plurality of responses satisfy the criteria and identifying the respective consumer respondent for each of the responses that is determined to satisfy the criteria as a candidate advocate for the organization.

2. The method of claim 1, wherein at least one of the of the primary question and the secondary questions is constructed as a Likert item statement in conjunction with a Likert-type scale as the response scale for the question from which one answer choice from the ordered list of answer choices is selected to specify a level of agreement or disagreement with the Likert item statement on an agree-disagree scale to answer the question.

3. The method of claim 1, wherein the respective correlation coefficients calculated for the secondary question are selected from the Pearson correlation coefficient, distance correlation, Brownian correlation, the randomized dependence coefficient, the correlation ratio, the polychoric correlation, and the coefficient of determination.

4. The method of claim 1, further comprising analyzing the respective correlation coefficients calculated for the secondary questions to generate a ranking of the secondary survey questions in terms of the level of dependency between the answer choices selected in the plurality of responses for each secondary question and the answer choices selected in the plurality of responses for the primary question from strongest correlation to weakest correlation based on a ranking of the corresponding respective correlation coefficients in descending order.

5. The method of claim 4, further comprising analyzing the generated ranking of the secondary questions to classify each of the secondary questions into one of a plurality of categories along a continuum based on the level of dependency between the answer choices selected in the plurality of responses for each secondary question and the answer choices selected in the plurality of responses for the primary question.

6. The method of claim 5, wherein the secondary questions are classified into the plurality of categories by evaluating the ranking of the corresponding respective correlation coefficients for the secondary questions to identify observable break points between sets of adjacent correlation coefficients in the ranking, defining the plurality of categories in correspondence with the observable break points, and assigning the secondary questions corresponding to each set of adjacent correlation coefficients to a respective category of the plurality of categories.

7. The method of claim 5, wherein the plurality of categories are defined to each correspond to a respective range of correlation coefficient values, and wherein the secondary questions are each classified into one of the plurality of categories based on the respective range of correlation coefficient values in which the respective correlation coefficient calculated for the secondary question falls.

8. The method of claim 5, wherein the threshold value corresponds to a minimum correlation coefficient value for the respective correlation coefficients calculated for the secondary questions that would allow a secondary question to be classified into a threshold category of the plurality of categories, and wherein the criteria specifies the answer choices for the set of secondary questions that can be selected in a given response to the questionnaire for the response to satisfy the criteria by specifying a respective minimum response value for the numeric values assigned to the answer choices for secondary questions classified into each of the threshold category and the categories of the plurality of categories into which secondary questions for which the respective correlation coefficients are greater than the respective correlation coefficients of any secondary questions classified in the threshold category are classified.

9. The method of claim 8, wherein the plurality of categories are defined along a continuum of level of dependency with the primary question to comprise a first category for secondary questions that highly correlate, a second category for secondary questions that moderately highly correlate, a third category for secondary questions that moderately correlate, a fourth category for secondary questions that weakly correlate, and a fifth category for secondary questions that negligibly or do not correlate, wherein the ordered list of answer choices for each secondary question comprises a first answer choice of “strongly agree” that is assigned a numeric value of five, a second answer choice of “agree” that is assigned a numeric value of four, a third answer choice of “no opinion” that is assigned a numeric value of three, a fourth answer choice of “disagree” that is assigned a numeric value of two, and a fifth answer choice of “strongly disagree” that is assigned a numeric value of one, wherein the second category is defined as the threshold category, wherein the respective minimum response value for the numeric values assigned to the answer choices for secondary questions classified into the second category is four, and wherein the respective minimum response value for the numeric values assigned to the answer choices for secondary questions classified into the first category is five.

10. The method of claim 1, wherein the scoring criteria further specifies, for each secondary question of the set of secondary questions for which the respective correlation coefficients are greater than a threshold value, whether the secondary question is required to be answered in a given response for the response to be able to satisfy the criteria.

11. The method of claim 1, further comprising accessing a respondent information database stored within the data store that maintains information describing the plurality of consumer respondents to obtain a set of respondent data describing each of the consumer respondents that is identified as a candidate advocate for the organization, and transmitting the set of respondent data to a client application executing on a user system for rendering a presentation of information pertaining to the candidate advocates identified for the organization within a user interface implemented at the client application for review by a user operating the user system, and wherein the information pertaining to the candidate advocates identified for the organization includes a name and contact information for each consumer respondent that is identified as a candidate advocate.

12. The method of claim 11, wherein the contact information for each consumer respondent that is identified as a candidate advocate comprises an email address for the consumer respondent, and further comprising automatically generating a respective endorsement solicitation request email message for each consumer respondent identified as a candidate advocate based on the set of respondent data in which the consumer respondent is requested to provide positive public feedback for the organization, and transmitting the respective endorsement solicitation request email message generated for each consumer respondent to the email address for the consumer respondent included in the contact information for the consumer respondent.

13. The method of claim 11, wherein the questionnaire further comprises a set of open-ended informational questions, and wherein the information describing the plurality of consumer respondents is compiled within the respondent information database based on answers that are provided to the set of open-ended information questions in the plurality of responses.

14. The method of claim 1, further comprising automatically calculating an advocacy quotient for the organization by determining a total quantity of consumer respondents of the plurality of consumer respondents, determining of quantity of consumer respondents that are identified as candidate advocates for the organization, calculating a percentage of a total quantity of consumer respondents of the plurality of consumer respondents that are identified as candidate advocates for the organization, and applying an index to the calculated percentage to thereby translate the percentage into the advocacy quotient.

15. A system for analyzing consumer feedback to identify candidate advocates for an organization, the system comprising:
an application server that provides a network service that is accessible to users through a plurality of client systems communicatively coupled to the application server via a network, the network service including an advocate identification application that is accessible via a user interface provided by a client application implemented on each of the client systems;
a data storage system storing a survey results database that comprises a set of survey results data representing a plurality of responses to a questionnaire that have each been completed by a respective consumer respondent of a plurality of consumer respondents based on a transaction the consumer respondent has engaged in with the organization, the questionnaire comprising a primary question that addresses a primary indicator of consumer loyalty and a plurality of secondary questions each addressing a corresponding aspect of consumer experience during transactions with the organization, each of the primary question and the secondary questions being constructed with a closed-ended ordinal response scale having an ordered list of answer choices that are each assigned a numeric value along a continuum corresponding to the response scale for the question and from which one answer choice is selected to answer the question;
wherein the advocate identification application includes:
a correlation analyzer that, upon a user operating one of the client systems to access the network service via the user interface provided by the client application implemented on the client system and submit a request to identify candidate advocates for the organization to the advocate identification application via the user interface, accesses the survey results database to obtain the set of survey results data and processes the survey results data to calculate a respective correlation coefficient for each secondary question that indicates a level of dependency between the numeric values assigned to the answer choices selected in the plurality of responses for the secondary question and the numeric values assigned to the answer choices selected in the plurality of responses for the primary question, and evaluates the respective correlation coefficients calculated for the secondary questions to define a criteria for assessing the plurality of responses to identify candidate advocates from the plurality of consumer respondents, the criteria specifying, for a set of secondary questions of the plurality of secondary questions for which the respective correlation coefficients are greater than a threshold value, which of the answer choices for the set of secondary questions can be selected in a given response to the questionnaire for the response to satisfy the criteria; and
an advocate identifier that evaluates the survey results data to determine which of the plurality of responses satisfy the criteria and identifying the respective consumer respondent for each of the responses that is determined to satisfy the criteria as a candidate advocate for the organization.

16. A computer apparatus, comprising:
a processor, and a memory storing computer readable instructions for execution by the processor to perform a method for analyzing consumer feedback to identify candidate advocates for an organization, and wherein the method comprises:
accessing a survey results database stored within a data store to obtain a set of survey results data representing a plurality of responses to a questionnaire that have each been completed by a respective consumer respondent of a plurality of consumer respondents based on a transaction the consumer respondent has engaged in with the organization, where the questionnaire comprises a primary question that addresses a primary indicator of consumer loyalty and a plurality of secondary questions each addressing a corresponding aspect of consumer experience during transactions with the organization, and where each of the primary question and the secondary questions is constructed with a closed-ended ordinal response scale having an ordered list of answer choices that are each assigned a numeric value along a continuum corresponding to the response scale for the question and from which one answer choice is selected to answer the question;
processing the survey results data to calculate a respective correlation coefficient for each secondary question that indicates a level of dependency between the numeric values assigned to the answer choices selected in the plurality of responses for the secondary question and the numeric values assigned to the answer choices selected in the plurality of responses for the primary question;
evaluating the respective correlation coefficients calculated for the secondary questions to define a criteria for assessing the plurality of responses to identify candidate advocates from the plurality of consumer respondents, where the criteria specifies, for a set of secondary questions of the plurality of secondary questions for which the respective correlation coefficients are greater than a threshold value, which of the answer choices for the set of secondary questions can be selected in a given response to the questionnaire for the response to satisfy the criteria; and
evaluating the survey results data to determine which of the plurality of responses satisfy the criteria and identifying the respective consumer respondent for each of the responses that is determined to satisfy the criteria as a candidate advocate for the organization.
